(19) United States
(12) Patent Application Publication
(10) Pub. No.: US 2023/0359194 A1
(43) Pub. Date: Nov. 9, 2023

(54) SYSTEM AND METHOD FOR PREDICTING SHUTDOWN ALARMS IN BOILER USING MACHINE LEARNING

(71) Applicant: The Cleaver-Brooks Company, Inc., Thomasville, GA (US)

(72) Inventors: John F. Dickson, Lewisville, TX (US); Rakesh Zala, Germantown, WI (US); Neeraj Kumar, Milwaukee, WI (US); Terry Gene Conger, Thomasville, GA (US)

(21) Appl. No.: 18/029,262

(22) PCT Filed: Feb. 2, 2021
(86) PCT No.: PCT/US2021/016255

§ 371 Date: Mar. 29, 2023

Related U.S. Application Data
(60) Provisional application No. 63/085,589, filed on Sep. 30, 2020.

(51) Int. Cl. G05B 23/02; F23N 5/24

(52) U.S. Cl. CPC G05B 23/0283; F23N 5/242

(57) ABSTRACT

Systems and methods for anticipating shutdown alarms for a boiler system by way of one or more machine learning (ML) or artificial intelligence (AI) models are disclosed herein. In an example embodiment, a method for anticipating shutdown alarms with respect to a boiler by way of a ML model includes receiving and storing, at one or more storage devices, a plurality of types of boiler-related data that are received at least indirectly from a plurality of internet of things (IoT) devices. The method also includes preprocessing and feature engineering the plurality of types of boiler-related data to arrive at a training data set, training the ML model, and deploying the trained model. The method further includes receiving additional boiler-related data concerning the boiler and, by way of the model, determining an alarm prediction concerning an anticipated alarm, and taking at least one action based at least upon the prediction.

### CROSS REFERENCE TO RELATED APPLICATIONS

This application claims priority to and the benefit of U.S. Provisional Application No. 63/085,589, filed on Sep. 30, 2020 and entitled “System and Method for Predicting Shutdown Alarms in Boiler Using Machine Learning,” the entire contents of which are hereby incorporated by reference in their entirety.

### FIELD

The present disclosure relates to monitoring and/or control systems and methods that can be employed in regard to boilers or boiler systems or in relation to the boiler industry and, more particularly, to such monitoring and/or control systems and methods that employ or involve machine learning or artificial intelligence and/or one or more Internet of Things (IoT) systems, components, or methods.

### BACKGROUND

Industrial boilers are employed in many environments, circumstances, and industries. For example, boilers are widely used in hospitals, in the food processing industry, and in the hospitality industries. In numerous such environments, circumstances, and industries, there are many processes that are dependent on the steam or water produced by boilers. Boilers often run around the clock to produce steam or water depending on the application. It thus is often desirable for boilers to be operated in a highly efficient manner and also desirable that shutdowns, especially unanticipated shutdowns, of boilers be avoided or limited.

Nevertheless, with respect to conventional boilers, many boiler operators struggle to run the boilers efficiently. Often, many of the operators have little or no experience optimizing boiler efficiency, which leads them to run the boilers inefficiently. Also, in many circumstances, an operator will mostly rely on the data shown on the user interface in the boiler, which typically does not show any historical data and does not help in making any decisions. Hence, an operator can often find it difficult to make decisions if the operator is not a boiler expert. Further, some facilities may use more than one boiler, which further complicates the task of operating the boilers.

The challenges associated with operating boiler systems are further exacerbated insofar as operators may be located remotely from the boilers. Boiler operating conditions can be difficult to monitor remotely when an operator is not near the boiler. Further, conventional boilers often need manual intervention to check if everything is running under normal conditions and to address any alarms that may have gone off. Additionally, typically manual intervention is required to restart the boilers.

As noted above, boiler shutdowns can be disadvantageous. Yet shutdown alarms and impromptu boiler shutdowns still frequently occur with respect to conventional boiler systems. In general, boiler systems employ two different types of alarms. The first type of alarm used in relation to boiler systems is called a shutdown alarm, and operates to shut a boiler down upon being triggered or activated. In contrast, the second type of alarm used in relation to boiler systems is merely a warning alarm, which does not operate to shut the boiler down even though triggered or activated.

Within the category of shutdown alarms, there are lock out shutdown alarms and auto reset shutdown alarms. Lock out shutdown alarms particularly can cause problems if the production of steam or hot water is stopped suddenly even though there may be a continuous requirement for steam or water. Such shutdown alarms require prompt attention—if no operator is present at a boiler when a lock out shutdown alarm goes off and the boiler is shut down, then the boiler will not be able to start again unless the reason for the alarm is addressed or an operator becomes aware of the alarm and resets the alarm. Hence, boiler shutdowns continued to pose significant challenges in relation to the operation of boilers.

Accordingly, it would be desirable if one or more new or improved systems or methods for monitoring and/or controlling boilers or boiler systems could be developed that alleviated or addressed one or more of the above-discussed concerns associated with conventional systems and methods, or alleviated or addressed one or more other concerns or disadvantages, or provided one more advantages by comparison with conventional systems and methods.

### BRIEF SUMMARY

The present disclosure, in a first example embodiment, relates to a method of anticipating shutdown alarms for a boiler system by way of one or more machine learning models. The method includes providing a boiler system having a controller and a plurality of sensors associated with a plurality of internet of things (IoT) devices, where the sensors are configured to sense a plurality of parameters regarding the boiler system and to provide a plurality of first signals regarding the sensed parameters to the controller. Additionally, the method includes causing all of the first signals regarding the sensed parameters regarding the boiler system, or information based upon the first signals, to be stored with at least one memory device, so as to maintain a historical database of the first signals or information based upon the first signals, and sending the first signals regarding the sensed parameters, or second signals based at least indirectly upon the first signals, to at least one gateway device of the boiler system. Also, the method includes further sending the first signals, the second signals, or third signals based at least indirectly upon the first signals or second signals, from the gateway device, for receipt by a cloud computing system and for use in either developing the one or more machine learning models for predicting the shutdown alarms or generating at least one prediction of one or more of the shutdown alarms by way of the one or more machine learning models. Additionally, the method includes receiving the at least one prediction of the one or more of the shutdown alarms.

Additionally, in a second example embodiment, the present disclosure relates to a system for anticipating shutdown alarms with respect to a boiler by way of machine learning model processing of information obtained by way of a plurality of internet of things (IoT) devices. The system includes a first controller supported on or proximate to the boiler, and a plurality of sensors associated with the plurality of internet of things (IoT) devices and also supported on or positioned proximate to the boiler, where the sensors are configured to sense a plurality of parameters regarding the boiler and to provide a plurality of first signals regarding the sensed parameters to the controller. The system also includes a gateway device of the boiler, where either the first signals or second signals based at least indirectly upon the first signals are sent to the gateway device. Further, the system includes at least one communications device by which either the first signals, the second signals, or third signals based at least indirectly upon the first signals or second signals, are sent for receipt by a cloud computing system, for use in either developing one or more machine learning models for predicting the shutdown alarms or generating at least one prediction of one or more of the shutdown alarms by way of the one or more machine learning models. Additionally, the system includes a display configured to receive at least one fourth signal indicative of the at least one prediction of the one or more of the shutdown alarms, and to display either the at least one prediction or one or more alerts in response to the at least one prediction, by way of an application programming interface (API).

Further, in a third example embodiment, the present disclosure relates to a method for anticipating shutdown alarms with respect to a boiler by way of a machine learning model. The method includes receiving and storing, at one or more storage devices, a plurality of types of boiler-related data, where the plurality of types of boiler-related data are received at least indirectly from a plurality of internet of things (IoT) devices associated with either the boiler or one or more additional boilers, and where the plurality of types of boiler-related data include each of firing rate data, oxygen level data, water level data, water temperature data, and fuel valve condition data. The method also includes preprocessing and feature engineering the plurality of types of boiler-related data to arrive at a training data set, training the machine learning model at least in part based upon the training data set, and deploying the trained machine learning model. The method further includes receiving additional boiler-related data concerning the boiler and, by way of the deployed, trained machine learning model and based upon the additional boiler-related data, determining an alarm prediction concerning an anticipated alarm regarding the boiler, and taking at least one action based at least upon the prediction concerning the anticipated alarm regarding the boiler.

Notwithstanding the above examples, the present invention is intended to encompass a variety of other embodiments including for example other embodiments as are described in further detail below as well as other embodiments that are within the scope of the claims set forth herein.

### BRIEF DESCRIPTION OF THE DRAWINGS

Embodiments of the disclosure are disclosed with reference to the accompanying drawings and are for illustrative purposes only. The disclosure is not limited in its application to the details of assembly or arrangements of components, or orderings of process steps, illustrated in the drawings. The disclosure is capable of other embodiments or of being practiced or carried out in other various manners. In the drawings:

FIG. 1 is a block diagram illustrating an improved boiler system that particularly includes an improved system for monitoring and/or controlling one or more boilers of the boiler system, in accordance with an example embodiment encompassed herein;

FIG. 2 is a schematic diagram illustrating an example method or manner of the flow of data within the improved system of FIG. 1;

FIG. 3 is a flow chart illustrating a first process by which machine learning (ML) or artificial intelligence (AI) is employed by the system of FIG. 1 in accordance with an independent model approach;

FIG. 4 is a flow chart illustrating a second process by which ML or AI is employed by the system of FIG. 1 in accordance with a sequential model approach;

FIG. 5 shows a top plan view of an example mobile device that can serve as a user interface of (or that operates in conjunction with) the improved boiler system of FIG. 1, and on which information/data presented in the form of an example dashboard is displayed as an image by way of a screen thereof; and

FIGS. 6, 7, and 8 respectively show second, third, and fourth images, respectively, which can also be displayed on the screen of the mobile device of FIG. 5.

### DETAILED DESCRIPTION

The present inventors have recognized that improved monitoring and/or control systems and methods for boilers or boiler systems or in relation to the boiler industry can be achieved by implementing machine learning (ML) or artificial intelligence (AI) and/or the Internet of Things (IoT) systems, components, or methods. The inception and development of the IoT has made solutions possible in regard to various complex unsolvable problems in various applications, in a variety of industries and operational contexts (or the operation industry). IoT systems, components, and methods can help with the remote monitoring of any of a variety of processes, and thereby decisions can be made more quickly and accurately. Indeed, with the help of IoT systems, methods, and components, and the information/data generated by such IoT systems, methods, and components, more intelligence can be added to a system to make smart decisions. The present inventors have particularly recognized that IoT systems, methods, and components can be employed in the boiler industry, for example, to perform remote monitoring and/or control of boilers and generate information/data regarding the operation of those boilers.

Additionally, the present inventors have also recognized that the impact of such IoT implementation can be both wide-ranging and profound if the operation IoT systems, methods, and/or components (a) occurs in relation to many (e.g., thousands of) boilers, and (b) occurs in combination with the implementation of machine learning (ML) or Artificial Intelligence (AI) use (e.g., so as to encompass thousands of boiler actions). In implementations involving ML or AI, the ML or AI can (depending upon the embodiment) focus virtually on all aspects of the boiler functionality and operation. Further, the capture of information/data regarding boiler operation that is made possible by the use of IoT systems, components, and methods is a key component to the development of useful ML or AI algorithms that can in turn be utilized for monitoring and/or controlling boilers. Indeed, to train or develop ML or AI algorithms and their respective data models to support boilers (or boiler OEMs), an important (perhaps the most important) step is to collect the most useful data. Upon the ML or AI algorithms being trained or developed, those algorithms can in turn be utilized for the monitoring and controlling of many boilers via the IoT.

The present inventors have particularly recognized that improved monitoring and/or control systems and methods for boilers/boiler systems that employ IoT as well as ML or AI can enable enhanced performance in relation to shutdown alarms. The useful data collected over years can be a great asset in building predictive models that can anticipate shutdown alarms that will happen in the future. Shutdown alarms can cause delays in an operation, which ML or AI can help reduce. Indeed, IoT with ML and/or AI can make these situations better with the help of data obtained via the IoT—ML or AI can serve to improve the conditions by predicting the alarm in advance, thereby alerting the boiler operator on how to avoid the alarm.

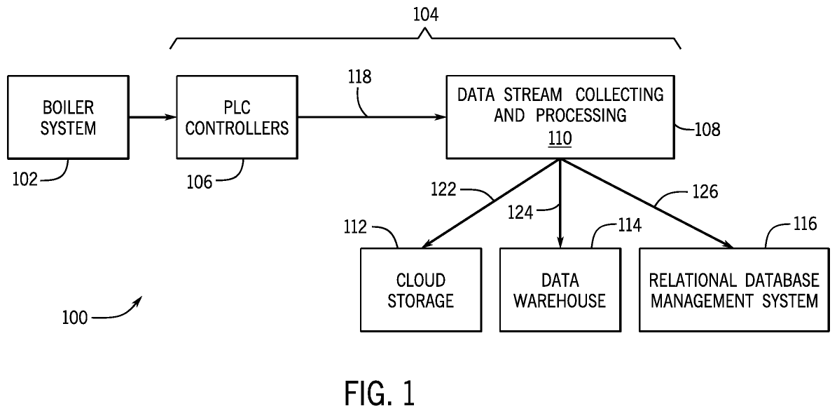

Referring to FIG. 1, a block diagram is provided that illustrates an improved system 100 that includes one or more boilers, shown as a boiler system 102, and an improved monitoring and control system 104 for monitoring and (or) controlling the one or more boilers of the boiler system 102, in accordance with an example embodiment encompassed herein. As shown, the improved monitoring and control system 104 in the present embodiment includes one or more programmable logic controllers (or PLCs or PLC controllers) 106 that are positioned within or proximate to the one or more boilers of the boiler system 102. Also as shown, the improved monitoring and control system 104 includes a remote processing system 108. The remote processing system 108 in the present embodiment is shown as including a data stream collecting and processing system 110, a cloud storage system 112, a data warehouse system 114, and a relational database management system 106. Further, the remote processing system 108 is shown to be in communication with the PLCs 106 by way of one or more communication links 118.

The one or more communication links 118 are intended to be representative of, depending upon the embodiment, any of a variety of different types or combinations of communication media or links. Among other things, the communication media or links that can be employed in various embodiments can include any of a variety of wired or wireless communication media or links involving electrical cables, coaxial cables, fiber optics or other optical communications media or technologies, digital subscriber lines (DSL), cellular technologies (e.g., 3G, 4G, LTE, or 5G), Bluetooth communications, Wi-Fi communications, radio wave, infrared, microwave, or other wireless or wired communications technologies. Given that, in the present embodiment the remote processing system 108 is envisioned as being positioned or located away from (remotely located from) the one or more boilers of the boiler system 102 and the associated PLCs 106, it is envisioned that the one or more communication links 118 typically will at least partly include wireless communication links (or wireless connectivity). Although it is currently envisioned that data will be transmitted via 4G or LTE signals, nevertheless in the future this can be modified to include the use of advanced wireless networks like 5G and even Local Area Network (LAN) or Bluetooth depending on the bandwidth required to stream data.

In the present embodiment, the communication links 118 particularly provide internet-based communications. Additionally, the PLCs 106 particularly can be considered to constitute, or encompass, IoT components or devices (or systems), which also can include discrete sensors or actuators associated with or mounted on the one or more boilers of the boiler system 102. The PLCs 106 can be considered IoT components insofar as the PLCs are in communication with the remote processing system 108 by way of internet-type communications afforded by the communication links 118. In the present embodiment, the PLCs 106 are configured to perform monitoring of the boiler system 102, at least by way of one or more sensors in or associated with the boiler system, and configured to communicate information/data (e.g., as sensed by the sensors) regarding the boiler system via the wireless communication links 118 for receipt by the remote processing system 108. Also, the PLCs 106 are configured to perform control actions in relation to the boiler system 102, at least by way of one or more actuators in or associated with the boiler system, based at least in part upon instructions or control signals received from the remote processing system 108.

The remote processing system 108 also performs operations related to the monitoring and control of the boiler system 102. It should be appreciated that the remote processing system 108 can take any of variety of forms depending upon the embodiment, and can include or encompass one or more processors and memory devices, as well as one or more input/output (I/O) devices and/or user interfaces. The one or more processors can take any of a variety of forms depending upon the embodiment, and can include any of a variety of one or more systems, components, or devices that perform any of a variety of types of processing or calculation operations. For example, depending upon the embodiment, the processors can respectively be implemented by way of respective hardware devices or components, firmware, or software implemented upon hardware encompassed by the processors. Also for example, the processors can be or include one or more microprocessors, one or more microcomputers, or one or more other forms of processing devices such as programmable logic devices (PLDs) or application specific integrated circuits (ASICs).

Likewise, the one or more memory devices can take any of a variety of forms depending upon the embodiment. In the present embodiment, data storage is provided by of the cloud storage system 112 and the relational database management system 116. In at least some embodiments, the cloud storage system 112 can be provided by a third party cloud storage provider and, additionally, in at the relational database management system can be provided by a third party. For example, in one example embodiment, the cloud storage system 112 takes the form of the Amazon simple storage system (S3) available from Amazon.com, Inc. of Belleview, Washington. Also, for example, in one example embodiment, the relational database management system 116 takes the form of a Microsoft SQL database provided by Microsoft Corp. of Redmond, Washington. In the present embodiment, information/data can be retrieved from either the cloud storage system 122 or the relational database management system 116 from any application programming interface (API) for any analysis purpose. Most data for customer user interface data is derived from relational database management system 116 (e.g., SQL database). Data for the ML/AI purposes can be pulled directly from the cloud storage system 112 (e.g., S3 storage).

Further with respect to the remote processing system 108, it should be recognized that information/data is streamed to the cloud storage system 112 (the cloud) by way of the data stream collecting and processing system 110. In the present embodiment, the data stream collecting and processing system 110 for example can take the form of the Amazon Kinesis Data Streams API also available from Amazon.com, Inc. In addition to being able to communicate information/data with respect to (to and from) the cloud storage system 112 as represented by an arrow 122, the data stream collecting and processing system 110 can further communicate information/data with respect to (to and from) the data warehouse system 114 and the relational database management system 116, as represented by arrows 124 and 126, respectively. In the present embodiment, the data warehouse system 114 for example can take the form of the Amazon Redshift data warehouse product also available form Amazon.com.

As described in further detail below, the remote processing system 108 particularly is configured to perform machine learning (ML) or artificial intelligence (AI) operations. That is, one or more processors or processing devices of or associated with the remote processing system 108 can perform functions or processing involving AI or ML, including those involving ML (or AI) models or neural networks, or involving other forms of related computer technologies or capabilities such as those employing intelligent agents or computerized learning (for example, deep learning, decision trees, etc.). Further in this regard, one or more processors/processing devices of the remote processing system 108 can in some embodiments, including those involving AI or ML, perform functions that involve reasoning or decision-making based upon information provided from any of a variety of sources, such as sensors or monitoring devices (e.g., devices providing perception), and/or that involve taking actions, which in some circumstances can entail causing or controlling actions by actuators. Relatedly, one or more memory devices in or associated with the remote processing system 108 (including, for example, one or more memory devices of the cloud storage system 112, the data warehouse system 114, and/or the relational database management system 116) can store models or neural networks, or other software or applications, employed for operation of the remote processing system 108 and improved system 100 by way of AI or ML.

Notwithstanding the above description regarding the improved system 100 and the systems and components thereof, the present disclosure is intended to encompass numerous other embodiments having different systems, components, features, or characteristics. For example, notwithstanding the description of the remote processing system 108 as being remote, the present disclosure is intended to encompass alternate embodiments in which a processing system serving as (or performing the same or substantially the same functions as) the remote processing system 108 is located at or proximate to the location of one or more boilers of a boiler system (and thus is not remote from the boiler system), or is coupled to PLCs 106 or other IoT components merely by way of wired communication link(s). Also, in alternate embodiments, one or more sensors or actuators associated with the one or more boilers of the boiler system 102 are distinct from the PLCs 106 and can communicate with the PLCs 106 also via internet-based (potentially wireless) communications. In such alternate embodiments, each of the distinct PLCs, sensors, and/or actuators can be considered a distinct IoT component or device.

The present disclosure is also intended to encompass any of a variety of other processing systems corresponding to the remote processing system 108 that (a) operate to store and process, including by way of ML or AI, information/data from the IoT (such as the PLCs 106) or other sources, and (b) can provide or communicate to the IoT or to other destinations additional information/data or instructions such as that resulting from the processing by way of ML or AI. In any given embodiment, the remote processing system (or other processing system, such as a central processing system) need not have each of a data stream collecting and processing system, cloud storage system, data warehouse system, and relational database management system, but rather can include other arrangements of processing and memory devices or systems. For example, in one alternate embodiment, the relational database management system 116 need not be present as part of the remote processing system. Also, in some embodiments, the remote processing system 108 can be in communication with (or even include) other computers and/or user interfaces such as those provided by personal computers or mobile devices such as smart phones.

Further for example, notwithstanding the above-discussed examples of systems and products that can serve as the data stream collecting and processing system 110, the cloud storage system 112, the data warehouse system 114, and the relational database management system 116, the present disclosure is intended to encompass the use of other systems, components, devices, or products as well. For example, in some alternate embodiments, the Azure cloud storage system available from Microsoft Corp. serves as the cloud storage system 112.

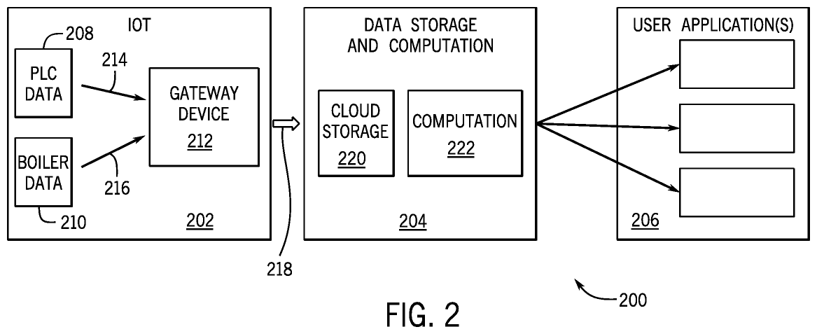

Referring additionally to FIG. 2, a schematic diagram 200 (taking the form of a modified data-flow diagram) is provided to illustrate an example method or manner of the flow of information/data within the improved system 100 of FIG. 1. As shown, in the present embodiment, the schematic diagram 200 includes a first IoT block (or phase) 202, a second data storage and computation block (or phase) 204, and a third user application(s) block (or phase) 206. FIG. 2 particularly is intended to show how information/data is transported in the IoT system, starting from where it is generated until it is consumed by a user.

Although the third user application(s) block 206 is intended to show a final step (e.g., an information/data consumption phase) of the method of FIG. 2, it should also be understood as representing one or more customer user interface(s) (e.g., computer monitors or displays) at which information/data, messages, or communications can be provided by the improved system 100 for receipt by or communication to customers (e.g., boiler operators associated with boiler owners). Further, it should be recognized that such customer user interface(s) not only make possible the communication of information to customers, but also the receipt of responses, commands, instructions, or other information/data from customers for use by the improved system 100 of FIG. 1. It should be further appreciated that such customer user interface(s) can be physically located at any of a variety of locations, including for example at the remote processing system 108, at location(s) at or proximate to the boiler system(s) 102, or at other locations. Additionally, in some embodiments, the customer user interface(s) can be mobile devices that are utilized by customers (e.g., where an application/app on the mobile device enables communication with other portions of the improved system 100). Further, although referred to above as customer user interface(s), it should be appreciated that the present disclosure envisions the implementation or use of any of a variety of types of user interface(s) that depending upon the embodiment can be accessed by or interface with any of various types of persons, parties, entities, or even other interfaces or computer systems.

The beginning of the method (which can be referred to as “the boiler IoT journey”) represented by the schematic diagram 200 can be understood as occurring at the one or more boilers of the boiler system 102 (see FIG. 1) itself, at which large amounts of information/data are generated. For example, the controls of a given boiler are programmed using a PLC system including one or more of the PLCs 106 (see FIG. 1) and these PLCs 106 can obtain data from all of the sensors associated with the boiler every second or at some other periodicity (or even possibly on a substantially continuous basis). The data arising from the boiler system 102 can be viewed as encompassing PLC data 208—e.g., data generated by the PLCs 106 based at least in part upon the sensed boiler data—and boiler data 210—e.g., unprocessed sensed boiler data. All of the PLC data 208 and boiler data 210 can be provided to a gateway device 212 using a network system as represented by arrows 214 and 216, respectively (the gateway device 212 can be considered to be part of the PLC controllers 106 shown in FIG. 1). In some embodiments, the network system can involve a bus operating in accordance with a protocol such as the fieldbus protocol of the monitored system. A boiler control with built-in ethernet communications capabilities is IoT ready.

As represented by an arrow 218, all of the PLC data 208 and boiler data 210 is communicated from the IoT block 202 to the data storage and computation block 204. The communication of the PLC data 208 and boiler data 210 particularly occurs as a communication between the gateway device 212 (or PLCs 106 as shown in FIG. 1) and the remote processing system 108 by way of the communication links 118 (again see FIG. 1). As particularly illustrated in FIG. 2, the PLC data 208 and boiler data 210 particularly is provided, within the data storage and computation block 204, for cloud storage as represented by a cloud storage block 220. As discussed with respect to FIG. 1, this can occur by way of the data stream collecting and processing system 110, which communicates the information/data received via the communication links 118 to the cloud storage system 112. The data is streamed and stored in a live environment (as when the data is generated). For example, the data can be streamed directly into the Amazon S3 storage system. In one example embodiment, such communication can occur every six (6) seconds when the real data is generated in every boiler. Such streaming of data can require a powerful network as can be provided, for example, in the form of the LTE/4G network. When stored in the cloud storage system (again, e.g., the Amazon S3 cloud storage system), the data can be stored permanently.

Upon data being received by the remote processing system 108 and stored in the cloud storage system 112, processing is performed at the remote processing system 108 by one or more of the processing devices of the remote processing system. Such processing and computation is represented by a computation block 222 in FIG. 2. In the present embodiment, several types of processing are particularly performed, and various tools are utilized to achieve or implement such processing. A first type of processing that is performed involves data exploration and analysis. That is, the data stored in the cloud storage system 112 (e.g., the Amazon S3 system) are explored, analyzed, and/or visualized. For example, the data can be explored and analyzed using software such as Python version 3.6 and visualized using Microsoft Power BI tools available from Microsoft Corp. It should be appreciated that, due to memory constraints, not all of the data may be stored in local memory. Data can be queried based on a given problem and a specific boiler. Visualization tools such as the Microsoft Power BI tool can be used to visualize the trend of the data and to identify relationship between the features and the outcome variables.

The number of types, and amounts, of information/data that can be obtained from the one or more boilers of the boiler system 102 and stored, explored, analyzed, visualized, and otherwise processed at the remote processing system 108 can be very large depending upon the embodiment. A variety of types of boiler data can be collected raw (or directly) from the PLCs 106 (or PLC system) that are in or associated with the one or more boilers of the boiler system 102. In the present embodiment, the data consists of a mix of numerical variables, nominal variables, and other categorical variables. The information/data of that is of interest can vary depending upon the embodiment or circumstance. For example, as discussed in more detail below, one or more embodiments encompassed herein operate to predict when an alarm may occur in regard to a boiler. To make such a prediction, more data is needed with lots of information (variables) than in some other circumstances. Further for example, in one embodiment, some of the boiler data that is of interest and that is collected can include data regarding each of firing rate, oxygen level, fuel valve position, type of fuel, stack temperature, water temperature, flame strength, etc.

Further in this regard, Table 1 shows all of the useful data types or data points that can be collected from a given boiler in one example embodiment—around one-hundred-and-eighteen (118) data points in all. It is envisioned, in this embodiment, that all of these types of data are collected every 6 secs and streamed directly into the cloud storage system 112 (or a proprietary cloud) via the data stream collecting and processing system 110. The data types shown in Table 1 particularly are useful for implementation of the ML (or AI) models as (like) boiler configuration data, as described in further detail below. Although intended exhaustive in terms of the data types useful for the ML (or AI) models in this embodiment, it is possible that other data types that are not useful for the ML (or AI) models are also available and/or can be collected.

TABLE 1
Example Data Collected from Boiler

| Drive Fault | Burner Switch | Oil Actuator Feedback Fail |
|---|---|---|
| Modbus | Alarm Output | Flue Gas Recirculation |
| Communication Error | | (FGR) Actuator Feedback |
| | | Fail Alarm |
| Low Water | Boiler Load Demand | Variable Speed Drive (VSD) |
| | | Deviation Alarm |
| Burner Control Alarm | Warm Up | Air/Fuel Deviation Alarm |
| High Stack Temp | High Water Alarm | Fuel Actuator Alarm |
| Alarm | | |
| High Stack Temp | Oil Actuator Out Of Pos | Stack Pressure Input Fail |
| Shutdown | Alarm | |
| External Interlock | FGR Actuator Out Of Pos | High Stack Pressure Alarm |
| | Alarm | |
| I/O module fault | Air Actuator Feedback Fail | Stack Damper Not Open |
| | Low Alarm | Alarm |
| Steam Sensor Fail | Air Actuator Feedback Fail | Oxygen (O2) Calibration |
| | High Alarm | Failed |
| No Fuel Selected | Natural Gas NG Actuator | Low Steam Pressure/Water |
| | Feedback Fail Low Alarm | Temp Alarm |
| Low O2 Alarm | NG Actuator Feedback Fail | O2 Trim Internal Alarm |
| | High Alarm | |
| High Limit Alarm | Oil Actuator Feedback Fail | VSD Limits Internal Alarm |
| | Low Alarm | |
| Auxiliary Low Water | Isolation Valve Out of | Gas Actuator 2 Out Of Pos |
| Cut-Off (ALWCO) | Position | Alarm |
| Low Gas Pressure/Low | Air Actuator Position | Gas Actuator Feedback Fail |
| Oil Temp | Deviation | |
| High Gas | Air Actuator Feedback Low | Actuator Modbus |
| Pressure/High Oil | | Communication Error |
| Temp | | |
| Low Oil Pressure | Air Actuator Feedback High | Water Temp Second Stage |
| | | Out High |
| High Oil Pressure | Air Actuator Modbus | Low O2 Shutdown |
| | Comm Error | |
| Oil Drawer Switch Not | Air Actuator Fault | Flame Strength Honeywell |
| Made | | |
| Low Atomizing Air | Air Actuator Not At | Combustion Air Fan Speed |
| Pressure | Lightoff | |
| Low Combustion Air | Fuel Actuator Not At | Boiler Efficiency |
| Pressure | Lightoff | |
| Stack Damper High | NOx Calibration Alarm | Firing Rate |
| Pressure | | |
| AUX Alarm 2 | Air Actuator Fault | O2 Level |
| Blower On | Air Actuator Not At | SP Steam Pressure/Water |
| | Lightoff | Temp |
| Purge Input | Fuel Actuator Not At | Water Level |
| | Lightoff | |
| Release To Modulate | NOx Calibration Alarm | Steam Pressure or Hot Water |
| Input | | Temp |
| Low Fire Switch | Safety Valve Setting or | Stack Temp Before |
| | Max Water Temp | Economizer |
| High Fire Switch | Header Pressure or Temp 2 | Combustion Air Temp |
| | Boiler LL | |
| Ready to start/Limits | Boiler Off Point | Water Temp Shell/Outdoor |
| Closed | | Temp |
| External Start Interlock | Boiler On Point | Stack Temp After |
| | | Econ/Return HW |
| Assured Low Fire Cut- | Feedwater Temp/Econ | Fuel Actuator Manual PB |
| Off (ALFCO) | Water Out Temp | Pressed |
| Pilot | AI Slot8Ch0 Value/2Stg | Burner Control Status |
| | Econ Temp IN | |
| Main Fuel Valve Open | Fuel Actuator Fault | VFD Feedback Low |
| Fuel Selected | Fuel Actuator Position | VFD Feedback High |
| | Deviation | |
| Low Water Cut-Off | Fuel Actuator Feedback | Flame Signal Fireye |
| (LWCO) Shutdown | | |
| Air Actuator Fault | Fuel 3 Actuator 2 Fault | Fuel Type |
| Fuel Actuator Fault | Fuel Actuator Modbus | Mix O2 Sensor Calibration |
| | Comm Error | Fail |
| FGR Actuator Fault | Stack Pressure | Number Of Cycles |
| Fuel Actuator Position | NOx PPM | Economizer Water In Temp |
| Deviation | | |
| Fuel Actuator Feedback | Isolation Valve Output | |
| Low | | |
| Fuel Actuator Feedback | Feedwater (FW) Valve | |
| High | Output | |

It should be recognized that IoT can produce large amounts of unstructured or semi-structured data on a continual basis, and that the data types listed in Table 1 are merely exemplary. Often, about twelve-to-fifteen (12-15) key data points are displayed on an IoT boiler dashboard even though, in some boiler systems, there are more than 250 data types or data points that can be monitored. As discussed in further detail below, the value of collecting all of these (or many) additional data points over time is that such data can help ascertain component life and predictive maintenance, and data analysis can lead to higher boiler system efficiency and an increased level of operational uptime. Data analysis can allow for correlations between data points to be made at a high level, ensuring the data is consistent enough to be accurate while enabling attempts to understand the outliers. By using algorithms or models such as the ML and AI models discussed further below, interactions between various factors and how factors influence or trigger one data point versus another can also be analyzed and determined, so as to enhance boiler system performance, reliability, and efficiency on numerous levels as also discussed further below.

In the present embodiment, the processing performed by the remote processing system 108 as represented by the computation block 222 at least partly includes ML (or AI) processing or operations. To operate in accordance with ML (or AI), one or more ML (or AI) algorithms or models are trained, built, developed, managed and deployed. In the present embodiment, this is accomplished within the Amazon Web Services (AWS) environment or ecosystem by several tools available from Amazon.com, Inc. As already discussed, collected IoT data is stored in AWS's S3 cloud storage system (serving as the cloud storage system 112). Further, the Python 3.6 programming tool (or open source python) is used to read or consume the data from the S3 cloud storage system and train/build the ML models that can be used to solve various problems. Further, the ML models that are trained/built, using python as the programming language, are then stored in S3 cloud storage system.

Additionally, in the present embodiment, the python hosting and ML model training particularly is performed in a large EC2 instance—that is, in a virtual server in the Elastic Compute Cloud (EC2) that provides elastic cloud computation as made available by Amazon.com, Inc. Performing these operations in the EC2 instance can solve various memory issues that can be caused when operated locally. Although such efforts are largely conducted within the AWS environment in this embodiment, code versions can be managed using the software development/version control services of GitHub, Inc., a subsidiary of Microsoft Corp.

As for deployment of the trained ML models, this can be performed through the use of Sagemaker, which is a cloud-based ML platform available from AWS. The deployment particularly can include a trained model in the S3 cloud storage system and an endpoint, to call the predictive model whenever a prediction is required on new data. As the new data is generated in the boiler, the model endpoint receives the data and generates the prediction (for example, an alarm prediction, as discussed further below), what will happen after x minutes. The true data (e.g., the latest boiler system data) is also collected after x minutes and compared with the prediction data x minutes back. In this manner, the ML model's score and accuracy (or “F1 score”) is constantly or frequently measured or verified. Retraining of the model is often necessary to constantly/frequently improve the accuracy of the model—the model can be retrained whenever the F1 score falls below a certain threshold value.

Notwithstanding the above discussion, other tools can also be employed to build the ML models. Although python can be installed in various environments, python particularly is suitable for conducting many proof of concept studies (e.g., in relation to smaller data sets). However, after proof of concept has been successfully demonstrated, it is often desirable to build the same model over again with larger amounts of data using a different tool. For example, the rebuilding of a model particularly can also be performed by way of the aforementioned Sagemaker platform, which is a self-managed tool that can handle both the model building and model deployment.

The present disclosure is intended to encompass a variety of embodiments and implementations in which ML (or AI) is utilized to achieve improved monitoring and/or controlling of one or more boilers or boiler systems, in any of a variety of circumstances or with respect to any of a variety of operational characteristics of boilers or boiler systems. In some example embodiments encompassed herein the improved system or method involves ML (or AI) that allows for enhanced prediction of the occurrence of alarms or alarm conditions/states in boilers or boiler systems. The methodology in such embodiments can be understood in general to include six steps.

First, the raw data generated by the boiler(s) or boiler system(s) and communicated via the IoT as discussed above is received, collected, and stored, at a certain frequency, in cloud storage—for example, in the cloud storage system 112 of the remote processing system 108 as discussed above. Second, the stored data is preprocessed. Third, the preprocessed data is then further processed to derive various features, by performing feature creation and feature engineering. Feature engineering is the process of adding, removing or modifying existing features, which tends to improve model performance—and a purpose of the feature engineering process can be to feed only the useful information to predict the outcome. The feature engineered data can also be stored in cloud storage at a certain frequency. Fourth, the preprocessed, feature engineered data is used (e.g., as training data set) to build one or more ML (or AI) models to predict various alarms. In this regard, the ML model(s) can for example take an independent form or sequential form as described further below.

Fifth, upon the ML model(s) being built and then deployed, the ML model(s) can be employed to predict alarms or alarm conditions of the boiler(s) or boiler system(s) based on ongoing data received from those boiler(s)/boiler system(s) (again, e.g., by way of IoT as discussed above). As discussed in more detail, the exact manner of implementing the ML models and interpreting the output of the models can vary depending upon the embodiment. Finally, sixth, one or more actions can be taken based upon the output(s) of the ML model(s) that are being utilized. In this example embodiment, in which the ML model(s) operate to predict alarms or alarm conditions/states, upon the ML model(s) predicting that there is (or will be) an alarm or alarm condition/state, then a notification is sent to a boiler operator through text message and email, along with the top five (5) recommendations as to how to fix the alarm.

It should be recognized that, in regard to the above methodology, feature creation and engineering is particularly important for model building, as it adds more information about the outcome variable(s)—indeed, some might consider it to be the most important step in building a machine learning model. As an example, in one embodiment encompassed herein, the “burner control alarm” (or Burner Alarm Warning) can be a dependent variable and the other features can be treated as independent features before (or in) the feature engineering process. Further in this example embodiment, as shown in Table 1, there are one-hundred-and-eighteen (118) useful variables obtained from IoT devices (a few other variables, which are not so important variables to be considered for ML purposes, are not listed). Not all of this information/data will be required to build the ML model, since keeping or removing the extra features will provide the same result and so it would cost extra time and money to attempt to utilize all of this information/data. Hence, in the feature engineering process, only the significant variables that actually correlate with the outcome variable are derived/selected. Further, during the feature engineering process, some new features are also created to provide more information about the data. Some examples of new features can include time(s) between pair(s) of events, count(s) of certain events happening within 30 minutes (or other time periods), etc. Principal component analysis is a common method that is used to derive the most significant variables from all the information provided.

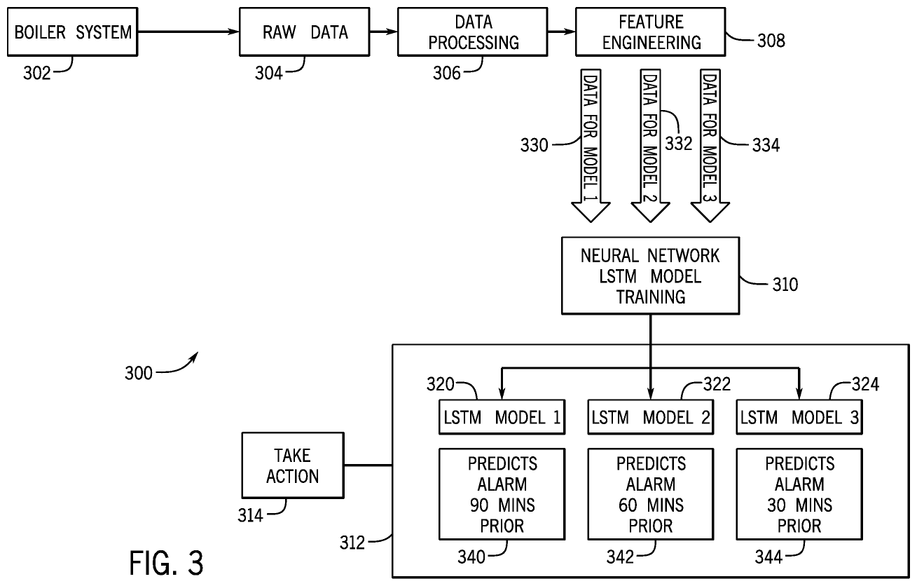

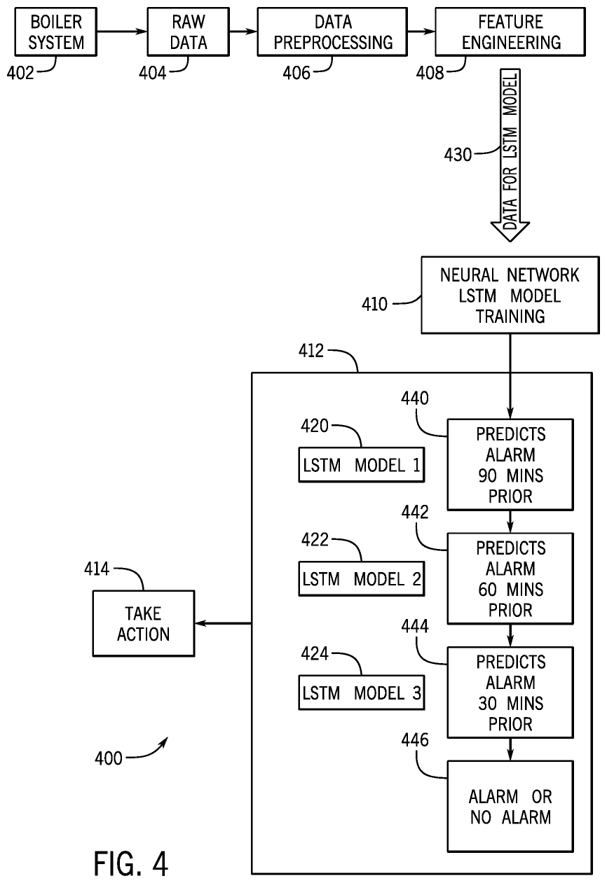

Turning to FIG. 3 and FIG. 4 respectively, a first flow chart 300 and a second flow chart 400 respectively are provided to illustrate two examples of improved methods of monitoring and controlling one or more boilers of the boiler system 102. Each of the two improved methods of the first and second flow charts 300 and 400 generally entail steps that are in accordance with the general methodology described above. In each case, the alarm variable collected from the boiler at every six seconds is the outcome variable and all other variables are the predictor variables or the independent variables. Also, in each case, there are three different models trained to predict the alarm at three different time intervals. The three models can repeatedly send feedback to the boiler operator about the boiler condition that is predicted to occur in the next 30, 60 and 90 minutes respectively. Also, in each case, as the probability of the prediction becomes higher, this indicates that the chance that an event (alarm) will happen is higher. In the present embodiment as discussed below, the ML models employed for each improved method utilize either of two different algorithms, namely, Xgboost and Long short term memory (LSTM) algorithm. Although these two algorithms are mentioned here, and have been utilized for evaluation and comparison purposes, the present disclosure is also intended to encompass the use of other types of models that utilize or are based upon other types of algorithms.

Although the improved methods represented by the flow chart 300 of FIG. 3 and flow chart 400 are similar in the above-described respects, the improved methods differ from one another in terms of the structuring of the three ML models employed in each method. From FIG. 3 and FIG. 4, it should be appreciated that the three models can either be structured independent of each other, where each model is independent of each other, or sequentially, where each model is dependent on previous model. More particularly, the improved method represented by the flow chart 300 shows an embodiment in which the three ML models are structured independent of each other, where each model is independent of each other. In contrast, the improved method represented by the flow chart 400 shows an embodiment in which the three ML models are structure sequentially, where each model is dependent on the previous model.

Referring particularly to FIG. 3, the flow chart 300 shows the independent model method or approach. As shown, the method can be understood to begin with the generation of information/data at the one or more boilers of the boiler system 102 and the communication of that information/data via the IoT, as represented by a preliminary step 302. Then, at a first step 304, that raw information/data (or simply data) is received at the remote processing system 108 and stored in the cloud storage system 112 thereof and, additionally at a second step 306, that stored information is preprocessed. Further, at a third step 308, the preprocessed information undergoes feature engineering. Next, at a fourth step 310, the preprocessed, feature engineered information is employed for the training of first, second, and third ML (LSTM) models 320, 322, and 324, respectively. Upon being trained (or built or developed), the ML models 320, 322, and 324 are then deployed and utilized at a fifth step 312 to predict or assess whether one or more alarms or alarm conditions/states is or are (or are likely to be) coming up within a given period of time (or periods of time). Based upon the prediction(s) provided at the fifth step 312, one or more actions can be taken in response to those prediction(s) at a sixth step 314.

In the present embodiment represented by FIG. 3, each of the first, second, and third ML models 320, 322, and 324 includes a respective neural network and takes the form of a LSTM model. As illustrated by first, second, and third arrows 330, 332, and 334 between the third step 308 and fourth step 310, the preprocessed, feature engineered information includes a respective first portion of data that is used in the training of the first ML model 320 (represented by the first arrow 330), a respective second portion of data that is used in the training of the second ML model 322 (represented by the second arrow 332), and a respective third portion of data that is used in the training of the third ML model 324 (represented by the third arrow 334). In the present example of the independent model approach, the three different (first, second, and third) ML models 320, 322, and 324 are trained to predict the same outcome variable using the same input variables, except the time intervals are different. The first ML model 320 uses ninety (90) minutes time interval data, the second ML model 322 model uses sixty (60) minutes time interval data, and the third ML model 324 uses thirty (30) minutes time interval data. This approach is intended to allow/facilitate the making of decisions starting from 90 minutes, far behind the actual event time, and getting closer to the 30 minute interval.

In the present example embodiment, the first, second, and third ML models 320, 322, and 324 are trained to predict alarms based upon input data/variables concerning one or more or the types of data shown above in Table 1. More particularly, the first ML model 320 as mentioned above operates to predict an alarm 90 minutes in advance. Such operation is achieved by training a LSTM model using all the predictor variables and the outcome variable (burner control alarm) such that, as shown in the following Equation (1):

y₁ₐ=f(X₁,X₂,X₃ . . . Xₙ), (1)

where each X=a respective one of the input (or predictor) variables from Table 1, n=the total number of input (or predictor) variables in Table 1, and y₁ₐ=Burner Alarm Signal (the outcome variable or dependent variable, alternatively referred to as the burner control alarm as mentioned above).

Further in relation to the first ML model 320, the training data is structured such that the input variables (independent variables) are moved back 90 minutes. Assuming that the data is received (collected or sampled), without any gap, every six (6) seconds over ninety (90) minutes, this results in nine-hundred (900) rows of data or sets of values (that is, if each of the input values X₁ through Xₙ is sampled every six seconds, there would be ten sets of those input values obtained every minute and thus nine-hundred sets of those input values obtained over ninety minutes). In this manner, the outcome variable remains at the same time period at which it is recorded. The first ML model 320 uses the data of what happened in the last 90 minutes and tries to build its relationship with the outcome variable that happened after 90 minutes time interval. This approach is used to predict the alarm that will happen after 90 minutes given the current data.

The output or outcome variable (y₁ₐ) of the first ML model 320 is indicative of a confidence level. If the output has very high value and therefore a high confidence level, for example, greater than 95%, then the event (e.g., alarm event) is very likely going to happen after 90 minutes. It should be recognized that the confidence level of the output of this model (y₁ₐ) will be correlated to the amount of data/examples. Accordingly, the output of the first ML model 320 will have a lesser confidence level if the model is not trained with a large amount of data with sufficient examples but, as the model collects (or is based upon) more data, the confidence level will improve. As the first ML model 320 sees more data and become more intelligent, it can increase the overall confidence level and make accurate model projections even at the 90 minutes timeframe.

By comparison, the second ML model 322 as mentioned above operates to predict an alarm 60 minutes in advance. Such operation is achieved by training a LSTM model using all the predictor variables and the outcome variable (burner control alarm) such that, as shown in the following Equation (2):

y_{1b}=f(X₁,X₂,X₃ . . . Xₙ), (2)

where each X=a respective one of the input variables from Table 1, n=the total number of input variables in Table 1, and y_{1b}=Burner Alarm Signal (the outcome variable, alternatively referred to as the burner control alarm as mentioned above).

Further in regard to this second ML model 322, the training data is structured such that the input variables (independent variables) are moved back 60 minutes. Assuming that the data is received (collected or sampled), without any gap, every six (6) seconds over sixty (60) minutes, this results in six-hundred (600) rows of data or sets of values (that is, if each of the input values X₁ through Xₙ is sampled every six seconds, there would be ten sets of those input values obtained every minute and thus six-hundred sets of those input values obtained over sixty minutes). In this manner, the outcome variable remains at the same time period at which it is recorded. The second ML model 322 uses the data of what happened in the last 60 minutes and tries to build its relationship with the outcome variable that happened after 60 minutes time interval. This approach is used to predict the alarm that will happen after 60 minutes given the current data. Again, it should be recognized that the confidence level of the output of this model (y_{1b}) will be correlated to the amount of data/examples. In this case, the confidence level of the second ML model 322 will be better than that of the first ML model 320, because the time duration has been reduced and the model has seen more new data, which increases the confidence level.

Further by comparison, the third ML model 324 as mentioned above operates to predict an alarm 30 minutes in advance. Such operation is achieved by training a LSTM model using all the predictor variables and the outcome variable (burner control alarm) such that, as shown in the following Equation (3):

y_{1c}=f(X₁,X₂,X₃ . . . Xₙ), (3)

where each X=a respective one of the input variables from Table 1, n=the total number of input variables in Table 1, and y_{1c}=Burner Alarm Signal (the outcome variable, alternatively referred to as the burner control alarm as mentioned above).

Additionally in regard to this third ML model 324, the training data is structured such that the input variables (independent variables) are moved back 30 minutes. Assuming that the data is received (collected or sampled), without any gap, every six (6) seconds over thirty (30) minutes, this results in three-hundred (300) rows of data or sets of values (that is, if each of the input values X₁ through Xₙ is sampled every six seconds, there would be ten sets of those input values obtained every minute and thus three-hundred sets of those input values obtained over thirty minutes). In this manner, the outcome variable remains at the same time period at which it is recorded. The third ML model 324 uses the data of what happened in the last 30 minutes and tries to build its relationship with the outcome variable that happened after 30 minutes time interval. This approach is used to predict the alarm that will happen after 30 minutes given the current data. Again, it should be recognized that the confidence level of the output of this model (y_{1c}) will be correlated to the amount of data/examples. In this case, the confidence level of the third ML model 324 will be the highest relative to each of the outputs of the first ML model 320 and second ML model 322 (y₁ₐ and, y_{1b}, respectively) because of the small time interval and more data being available to predict the occurrence of an alarm event.

In view of the training of each of the first, second, and third ML models 320, 322, and 324, respectively, it should be further appreciated that the fifth step 312 of the method of FIG. 3 actually involves the making of first, second, and third predictions (and confidence levels) 340, 342, and 344, respectively, based upon those respective ML models. Upon those three predictions 340, 342, and 344 being determined, the fifth step 312 can additionally include the calculation of an overall prediction (and confidence level) regarding whether one or more alarms or alarm conditions/states will occur. Depending upon the embodiment, any one or more of the first, second, and third predictions 340, 342, and 344, or any additional prediction made based upon one or more of those first, second, and third predictions, can serve as a basis for one or more actions being taken at the sixth step 314.

Referring next to FIG. 4, in contrast to the independent model method or approach of the flow chart FIG. 3, the flow chart 400 shows the sequential model method or approach. As shown, this method can also be understood to begin with the generation of information/data at the one or more boilers of the boiler system 102 and the communication of that information/data via the IoT, as represented by a preliminary step 402. Then, at a first step 404, that raw information/data (or simply data) is received at the remote processing system 108 and stored in the cloud storage system 112 thereof and, additionally at a second step 406, that stored information is preprocessed. Further, at a third step 408, the preprocessed information undergoes feature engineering. Next, at a fourth step 410, the preprocessed, feature engineered information is employed for the training of first, second, and third ML (LSTM) models 420, 422, and 424, respectively. Upon being trained (or built or developed), the ML models 420, 422, and 424 are then deployed and utilized at a fifth step 412 to predict or assess whether one or more alarms or alarm conditions/states is or are (or are likely to be) coming up within a given period of time (or periods of time). Based upon the prediction(s) provided at the fifth step 412, one or more actions can be taken in response to those prediction(s) at a sixth step 414.

In contrast to the independent model approach of FIG. 3, the sequential model approach of FIG. 4 entails using the three different (first, second, and third) models 420, 422, and 424 in a sequential manner to obtain one prediction after the other. The third model then provides, or is the basis for providing, the final outcome prediction regarding (in this embodiment) whether an alarm or alarm conditions/state will occur or not at a given time. More particularly, the first ML model 420 operates to predict an alarm ninety (90) minutes in advance. Such operation is achieved by training a LSTM neural network using all the information from Table 1 to predict the alarm 90 minutes in advance, as an output or outcome variable (y₂ₐ), in accordance with the following Equation (4):

y₂ₐ=f(X₁,X₂,X₃ . . . Xₙ), (4)

where each X=a respective one of the input variables from Table 1, n=the total number of input variables in Table 1, and y₂ₐ=Burner Alarm Signal (the outcome variable, alternatively referred to as the burner control alarm as mentioned above).

In this example embodiment, the data for the first ML model 420 is structured such that all of the predictor variables are moved back 90 minutes. The outcome variable (alarm data) will remain at the same time frame at which it is recorded. Thus, a data point generated 90 minutes back will represent the current alarm state. The output or outcome value of the first ML model 420 (y₂ₐ) is a score between 0.1 to 0.99, where a value of 0.1 indicates that an alarm occurrence is very less likely (or very unlikely) and a value of 0.99 indicates that an alarm occurrence is very likely.

By comparison, the second ML model 422 operates to predict an alarm sixty (60) minutes in advance. Such operation is achieved by training a LSTM neural network trained using all of the data from Table 1 and (in combination with) the output of the first ML model 420 (y₂ₐ), so as to predict the alarm 60 minutes in advance, as an output or outcome variable (y_{2b}), in accordance with the following Equation (5):

y_{2b}=f(X₁,X₂,X₃ . . . Xₙ,y₂ₐ), (5)

where each X=a respective one of the input variables from Table 1, n=the total number of input variables in Table 1, and y_{2b}=Burner Alarm Signal (the outcome variable, alternatively referred to as the burner control alarm as mentioned above).

The data for the second ML model 422 is structured such that all of the predictor variables are moved back 60 minutes. Thus, the outcome variable (y_{2b}, the alarm data or Burner Alarm Signal) will remain at the same time frame at which it is recorded. Thus, a data point generated 60 minutes back will represent the current alarm state. The output or outcome value of the second ML model 422 (y_{2b}) is a score between 0.1 to 0.99, where a value of 0.1 indicates that an alarm occurrence is very less likely (or very unlikely) and a value of 0.99 indicates that an alarm occurrence is very likely.

Additionally by comparison, the third ML model 424 operates to predict an alarm thirty (30) minutes in advance. Such operation is achieved by training a LSTM neural network using all the data from Table 1 and (in combination with) the output of the second ML model 422 (y_{2b}), so as to predict the alarm 30 minutes in advance, as an output or outcome variable (y_{2c}), in accordance with the following Equation (6):

y_{2c}=f(X₁,X₂,X₃ . . . Xₙ,y_{2b}), (6)

where each X=a respective one of the input variables from Table 1, n=the total number of input variables in Table 1, and y_{2c}=Burner Alarm Signal (the outcome variable, alternatively referred to as the burner control alarm as mentioned above).

The data for the third ML model 424 is structured such that all of the predictor variables are moved back 30 minutes. Thus, the outcome variable (y_{2c}, the alarm data or Burner Alarm Signal) will remain at the same time frame at which it is recorded. Thus, a data point generated 30 minutes back will represent the current alarm state, and the output or outcome variable of the third ML model 424 (y_{2c}) determines whether an alarm will occur or not within next 30 minutes. The output or outcome value of the third ML model 424 (y_{2c}) is a score between 0.1 to 0.99, where a value of 0.1 indicates that an alarm occurrence is very less likely (or very unlikely) and a value of 0.99 indicates that an alarm occurrence is very likely. Again, the third ML model 424 becomes very effective as more data is collected. Because the third ML model 424 uses the output of the other two (the first and second) ML models 420 and 422, the confidence level of the outcome variable of the third ML model 424 (y_{2c}) tends to increase with the scores obtained by way of the first ML model and the second ML model.

Although the above description particularly involves LSTM ML models, the present disclosure is intended to encompass a variety of other embodiments of improved systems or methods for monitoring and/or controlling boilers or boiler systems that employ or operate based upon any one or more of a variety of ML (or AI) models or algorithms. For example, as already mentioned above, in at least one embodiment encompassed herein, the improved system operates as (or improved method provides) an alarm alerting system that predicts (or facilitates predicting of) alarms or alarm conditions/states, and particularly employs two main ML algorithms given the nature of the data and the problem. More particularly, because the alarm occurs based on the sequence of events happening, both the LSTM ML model and the Xgboost ML model are used.

With respect to the LSTM ML model, this model is helpful for solving the vanishing or exploding gradient problem while using a recurrent neural network. A typical neural network model uses back propagation to update the weights as it goes through the layer. As the weights propagate, it is possible for the value to become very small or very high, and these two scenarios can pose challenges while training a neural network. In view of these considerations, LSTM ML models can be useful in that such models have the capability to learn long term dependencies—that is, LSTM ML models can remember information for long periods, which can be very useful in relation to boiler operations.

With respect to the Xgboost (Extreme Gradient Boosting) ML model, gradient boosting models envision (or involve) the repeated building of new models to correct the error(s) made by the previous models. The models are added sequentially until no more error adjustments are made. Such a model is referred to as a gradient boosting model particularly because the model uses a gradient descent algorithm to minimize the loss when adding new models.

As an example of such a gradient boosting model, let I₁ be an initial model built using X₁, X₂ . . . Xₙ and y₁, where n is the total number of predictor variables (e.g., from Table 1) and y₁ is the outcome variable (e.g., the burner control alarm or Burner Alarm Signal). A new model R₁ can be fit to the residuals of model I₁, the difference between the actual and the predicted value, such that the boosted version of I₁ (I₂) is a combination of I₁ and R₁ in accordance with Equation 7:

I₂(x)=I₁(x)+R₁(x). (7)

Given this scenario, to improve the model I₂(x), we further use the residuals of I₂(x) to create I₃(x) and so on until Iₙ(x), in accordance with Equation 8 as follows:

Iₘ(x)=Iₘ₋₁(x)+Rₘ(x), (8)

where m is the number of iterations that lowers the residuals (error rate).

Further in the present embodiment, ML models trained by both (or as either of) Xgboost and LSTM models are validated (in a model validation process) using accuracy and other metrics. Recall metrics, precision metrics, and F1 score metrics are respectively used to help reduce the false negatives and false positives, where these respective types of metrics are calculated in accordance with the following Equations 9, 10, and 11, respectively:

$$Recall = \frac{True Positives}{True Positives + False Negatives} ; \qquad ( 9 )$$

$$Precision = \frac{True Positives}{True Positives + False Positives} ; and \qquad ( 10 )$$

$${F}_{1} = 2 * \frac{P r e c i s i o n * R e c a l l}{P r e c i s i o n + R e c a l l} . \qquad ( 11 )$$

In regard to Equations 9, 10, and 11, false negatives state that (indicate situations in which), even though the model classified no alarm status after x minutes, in reality the alarms happened after x minutes. This scenario will typically cost time and money in boiler operation, and so reducing false negatives will make the solution better for the problem. In contrast, false positives state that (indicate situations in which), even though the model predicted that an alarm would go off after x minutes, in reality the alarm did not go off after x minutes. This situation can be troublesome for boiler operators since the boiler operators will have to constantly check on the boilers during such false alarms. Hence, the ML model validation focuses on achieving a balance between false positives and false negatives. Accuracy is not the best metric to validate such ML models, since the amount of positives in the data is very less (low).

It should be appreciated that the ML (or AI) model has a degree of adaptability (exhibits high model adaptability) insofar as the ML model has an ability to adapt to (or be adapted to) different boiler setups at various sites. For example, some sites are equipped with more than one boiler and referred to as multi-boiler sites. In the case of a multi-boiler site, the condition of one boiler is monitored relative to other boilers. In most industries, extra boilers are used to address increases in hot water or steam demand. There is typically one boiler that leads the steam or hot water generation process, which is referred to as the lead boiler. Other boiler(s) in the site are called lag boilers. The behavior(s) of lag boiler(s) is/are heavily dependent on the lead boiler. Consequently, although a lead boiler in one site can be compared to lead boiler(s) in other site(s), the lag boilers in one site cannot typically be compared the ones in other sites—that is, comparing lag boilers with boilers in other sites will not be ideal.

Given these considerations, in circumstances involving lead and lag boilers, the data are structured in a way that the ML (or AI) model understands the relationship between the lead and lag boiler(s) (at the site). Various patterns in data are captured by the ML (or AI) model between the lead and the lag boilers. Further, data patterns are analyzed before building the ML model. The data patterns are fed into the ML model in the form of features, which the model will learn and that allow for making accurate predictions depending on whether the boiler is a lead boiler or a lag boiler. Having enough data, the reason for an alarm prediction will also be derived based on the patterns observed in the lead boiler and lag boiler units.

The improved systems and methods disclosed and encompassed herein are intended to be useful or suitable with respect to any of a variety of boilers, boiler controls, boiler systems, and other applications. For example, the shutdown alarm prediction models encompassed by the present disclosure (which allow for the providing of alarm monitoring services) can be trained for use in relation to any one or more of a variety of boiler types, and for implementation as part of or in conjunction with any of a variety of boiler monitoring or control systems. The present disclosure is intended to encompass improved systems and methods for monitoring and/or controlling boilers and boiler systems, as well as improved boilers/boiler systems that include such improved monitoring and/or control systems. Further, in some embodiments, one or more aspects of the improved systems and methods disclosed or encompassed in the present disclosure can be added to or implemented in (as improvements to) any of a variety of existing or conventional boiler monitoring or control systems including, for example, Hawk Boiler controls such as any of the Hawk ICS, Hawk 1000, Hawk 4000 and Hawk 4000 V2 boiler controls available from Cleaver-Brooks, Inc. of Thomasville, Georgia.

It is envisioned that, in at least some embodiments, the improved system or method for monitoring and/or controlling boiler(s) or boiler system(s) will include either the sequential model or the independent model discussed above, respectively, in regard to FIG. 3 and FIG. 4, respectively, and that at least one of those ML models will be used to implement the alert system. In some such embodiments, the independent model will provide three outputs (e.g., three types of output or output signals) that respectively are 90 minutes, 60 minutes and 30 minutes in advance, as for example is represented by the fifth step 312 of FIG. 3. Alternatively (or additionally), in some such embodiments, the sequential model will provide a single output (e.g., a single type of output or output signal) which is 30 minute in advance, as for example is represented by the sixth step 412 of FIG. 4.

Further, in at least some embodiments, any one or more of a variety of actions can be taken by the improved monitoring and/or control system, in accordance with the sixth step 314 of FIG. 3 or the sixth step 414 of FIG. 4. For example, the outputs provided at the fifth step 312 of the method of FIG. 3, or provided at the fifth step 412 of the method of FIG. 4, can be provided to and consumed by an API and, additionally, the output(s) (or information based upon the output(s)) can be shown in customers' user interface(s). Further in this regard, the customers' user interface(s) can display in real time various key performance indicators of the boiler(s)/boiler system(s) that are being monitored or controlled—including, for example, performance indicators such as, oxygen (O₂) level, stack temperature, operating pressure, firing rate, water level, flame strength, etc. Also, in some such embodiments, if the improved monitoring and/or control system determines with high confidence that a boiler/boiler system will be experiencing an alarm (that is, the boiler is anticipating an alarm with high confidence), then the system will cause the boiler operator to be alerted with a text message or an email to take necessary actions.

The taking of actions at the sixth step 314 or the sixth step 414 can also include, in some embodiments, the sending of one or more messages to boiler operators that provide one or more prescriptive solutions intended to prevent the future occurrence of one or more predicted alarms or alarm conditions/states. The ML models can have the capability to predict the outcome of an event given a set of conditions at a certain confidence level. To prevent an upcoming alarm, subject matter experts in the industry have identified (or set) specific standards to be prescribed depending on the condition of the alarm. Standards and prescriptions derived from subject matter experts are particularly appropriate when limited data is available, although prescriptive actions can be derived (e.g., automatically derived) from the data if larger amounts of data (e.g., multiple years' worth of data) are available. In the case of a burner control alarm being predicted, one or more of the following are the prescriptions based on the experts: (a) check the pilot flame; (b) check the burners; (c) check the ignition; (d) check the fuel supply; and (c) check the communication from flame safe guard. These prescriptions are sent to the boiler operator during an alert, when the alarm is most likely going to happen.

Notwithstanding the above description relating to FIGS. 1, 2, 3, and 4 concerning improved systems and methods, the present disclosure is intended to encompass numerous additional embodiments and implementations including additional, or different, system features, components, devices, attributes, or characteristics than those described above. For example, although the improved system 100 envisions that the PLCs 106 are associated with the boiler system 102, in alternate embodiments encompassed herein other types of controllers, computers, or processors can be utilized in relation to, or associated with, boiler(s)/boiler system(s). It should also be recognized that, in some embodiments encompassed herein, IoT (e.g., IoT devices as discussed above) enables the collection and provision of information/data that can be reviewed, analyzed, or processed by systems such as the remote processing system 108 (e.g., through the use of ML or AI), but any control actions taken based upon such review, analysis, or processing are not taken by way of the IoT. Alternatively, in other embodiments encompassed herein, the IoT not only enables the collection and provision of information/data for review, analysis, or processing by systems such as the remote processing system 108, but also serves to control (or aids in the control of) the boiler(s)/boiler system(s).

Additionally, in some other embodiments, other types of data structures can be used to implement (or validate) the solution. For example, although data associated with the independent and sequential ML models discussed above in relation to FIG. 3 and FIG. 4 can be structured by moving the data backward, in alternate approach, thirty (30) minutes of data can be grouped together such that one data (or data set) represents 30 minutes' worth of raw data. The grouped or the transformed data can summarize statistics of (or provide summary statistics) concerning the 30 minutes of data such as mean, median, mode, minimum and maximum statistics. Further, depending upon the embodiment, the number of predictor or independent variables that are utilized in training or deploying the ML (or AI) models can vary. For example, although the independent and sequential ML models described with respect to FIG. 3 and FIG. 4 utilize all the predictor variables discussed in Table 1 (all 118 variables), according to another data transformation the number of predictor variables that are considered will be limited to a smaller number of variables. For example, in one such embodiment, five (5) variables—for example, firing rate, oxygen level, water level, water temperature and fuel valve condition—can be used to predict the shutdown alarms.

Further, in additional or alternate embodiments, additional types of algorithms, models, and/or ML (or AI) methodologies can be employed instead of or in addition to the LSTM and Xgboost algorithms mentioned above. For example, in some such embodiments, other algorithms, models, and/or ML (or AI) methodologies including any one or more of random forest algorithms, linear regression and time-series models, support vector machines or neural networks are employed. The use of additional algorithms, models, and/or ML (or AI) methodologies becomes increasingly practical as more data becomes available. The use of more algorithms, models, and/or ML (or AI) methodologies can provide flexibility to evaluate various model performances.

Further, notwithstanding the particular methods and orderings of steps of the methods described above, the present disclosure is intended to encompass methods that include additional, or fewer, steps than the methods described above, or that include steps that occur in different orders than as described above. For example, in some other embodiments, IoT data is stored at the PLCs 106 in addition to being stored at the remote processing system 108. Also for example, with respect to the steps 304 and 404 of FIGS. 3 and 4, it should be appreciated that in some embodiments the receiving of raw data at these steps can also include additional steps (or substeps) such as (a) storing such raw data in memory device(s) at the boiler(s)/boiler system(s) at which that raw data is obtained or in the PLCs 106 associated with those boiler(s)/boiler system(s), (b) communicating such raw data from the boiler(s)/boiler system(s) or associated PLCs 106 to a gateway device such as the gateway device 212, and (c) communicating such raw data (or other information/data) from the gateway device to the remote processing system 108.

As already discussed above, in a first phase of implementing the solutions described herein, it is envisioned that these solutions will be implemented in (as improvements to) Hawk Boiler control systems (e.g., Hawk ICS, Hawk 4000, Hawk 1000 and Hawk 4000V2). The implementation will also be implemented in (roll up to) further control systems such as ADAC (e.g., the Hawk ADAC Advanced Deaerator Control) and Master Panel (Hawk Master Panel), which is used to control several boilers in one site, as are also available from Cleaver-Brooks, Inc. Nevertheless, even though it is envisioned that at least some embodiments described herein can be implemented in or as part of (as improvements to) existing or conventional control systems such as any of the Hawk Boiler control systems mentioned above, it is also envisioned that the improved systems and methods described herein (or aspects thereof) can be extrapolated to adapt other systems as well. For example, by integrating data from various Hawk Boiler systems, the shutdown prediction models can be deployed in various other boiler systems. In some such embodiments, the data structure would remain the same, relative to what might be employed in the above-discussed embodiments suitable for Hawk Boiler control systems.

Further, the data streaming from other IoT can be matched to the data of the Hawk systems using a data transformation module (the compatibility between the Hawk PLC and other PLC systems would be addressed before integrating and transforming the data). Further, although the above description relating to FIGS. 1, 2, 3, and 4 particularly relates to improved systems and methods for monitoring and/or controlling boiler(s)/boiler system(s) that operate in particular manners as shutdown prevention system and methods (e.g., which operate to predict upcoming alarms and take actions that can avoid undesirable boiler shutdowns), the present disclosure envisions and encompasses numerous other embodiments of improved systems and methods that provide other functions and/or take other actions. For example, although the above-described embodiments employ ML models that anticipate alarms within next 30, 60 or 90 minutes as timeframes, in other embodiments the anticipation window(s) can be longer in length (e.g., hours in advance). This particularly can become possible as more data is available to develop the models. Indeed, in the future with more data and ML capabilities, ensemble models can be built to predict alarms in any time interval(s). Also, if the decision making process is quicker, the time window can even be shorter so that the accuracy of predicting alarms will be very high.

Additionally, the present disclosure also is intended to include numerous embodiments that employ ML or AI to perform functions or achieve objections that are in addition to, or different from, predicting alarms or taking actions in regard to such predictions. The improved system 100 described above (e.g., the remote processing system 108 thereof), or modified versions of that improved system also encompassed herein, are capable of significant data analytics based upon the wealth of information/data made available to the system by IoT (or possibly from other sources). The IoT—particularly the significant information/data made available from the IoT—enables the review, analysis, or processing of such information/data to generate any of a variety of types of information/data that can provide bases for taking actions or be sent to customer(s) to improve operations. In some example embodiment encompassed herein, the improved system logs, tracks data, and (depending on trend) sends messages to customers to improve boiler operation and/or efficiency and to minimize auto-reset or lock out type shut down alarms. The present disclosure is intended to encompass embodiments that serve to improve boiler operation even when there are no alerts or shut downs. The types of review, analysis, and processing performed in regard to various types of type of information/data in these various embodiments need not, in some embodiments, utilize the particular neural networks, LSTM, or Xgboost models, algorithms, technologies discussed above, but rather can employ other or additional models, algorithms, or technologies.

Among other things, at least some embodiments encompassed herein can perform review, analysis, and processing that allows for the discernment and use of boiler operational characteristics, to diagnose trends, to take actions in response, and to generally provide operation monitoring services. By examining boiler system operation over time, opportunities for improvements can be discerned or revealed. When IoT-provided information/data is filtered through analytical software powered by models or algorithms such as ML or AI-based models or algorithms as discussed above (e.g., at the remote processing system 108), this information can provides customers, owners, boiler operators, maintenance crew members, and others better insight into when boiler systems need their attention, which can decrease downtime and maintenance costs. Indeed, IoT-connected boilers can provide remote monitoring and value-added insights into many key performance indicators such as, for example, stack temperature, flame signal strength, boiler on/off cycles per hour, oxygen level, and steam pressure and firing rate monitoring as described further below.

More particularly, with respect to stack temperature, it will be recognized that maintaining the correct stack temperature is a good indication that a boiler system is running smoothly. Long-term data collection and cloud storage enable an IoT solution to allow detection of a gradually increasing stack temperature. By looking at the trend chart on a user interface (e.g., a IoT dashboard as described further below), a user will know the boiler system is not transferring heat effectively, and system efficiency is likely dropping. The user can then identify the cause and rectify the issue before it becomes a problem. For example, perhaps in such a circumstance, the boiler system needs to be serviced or cleaned. Also for example, if the system is burning clean, perhaps the problem is due to scaling or water chemistry. Although such a boiler system problem could worsen and ultimately lead to unscheduled downtime for the boiler system if left undiagnosed and unattended, identification of the problem through trend analysis allows for a user to gain knowledge of the existence of the problem and to take action—such as scheduling maintenance at a time that is not disruptive to the operation of the boiler system.

With respect to flame signal strength, it will be recognized that maintaining a strong flame can help to enhance the reliability and safety of boiler performance. There are a number of possible reasons for a weak flame signal including, for example, improper air flow, poor air-to-fuel mixing, or a malfunction of the flame scanner. Through the use of an improved system for boiler monitoring and/or control as encompassed herein, it is possible based upon IoT-provided information/data to detect a weak flame signal (e.g., as defined by the boiler original equipment manufacturer (OEM)) and, upon such a circumstance being detected, taking action to alert a user immediately. Being able to review current and historical data will help to narrow down the potential cause, thus correcting the issue to maintain desired, reliable and safe operation. At the same time, in this regard, the use of the term “safe” herein is not a representation that the embodiments of systems and methods encompassed herein will make any given boiler-related system or process safe (or that other systems will produce unsafe operation). Safety depends on numerous factors outside of the scope of the present disclosure including, for example, boiler system design, installation, maintenance, and cooperation and training of individuals using or implementing the system. All physical systems are susceptible to failure and provision must be made for such failure.

With respect to on-off cycles, it will be appreciated that it is normal for a boiler to undergo on-off cycles. However, if there is excessive cycling and no adjustments are made, and the boiler continues to cycle excessively, unscheduled downtime is the predicted outcome. In addition, overly-frequent cycling amplifies fuel costs because every time the boiler cycles, it purges, removing energy from the boiler, which reduces operating efficiency and leads to higher energy costs. There are a number of reasons why a boiler may be cycling frequently. For example, the boiler may be oversized for the process, the steam set pressure and high limit may be too close, or the boiler may not have a high turndown burner (or the too-frequent cycling may be due to something else). In view of such considerations, in at least some embodiments encompassed herein, the improved system (e.g., the remote processing system 108) operates to review, analyze, and process IoT information/data regarding boiler cycling, so as to generate a trend report concerning such cycling. If a trend report indicates that an industrial boiler is cycling excessively frequently (e.g., eight-to-nine times per hour), the remote processing system 108 can generate and send a signal to prompt a user to begin an investigation.

As for oxygen level, it will be recognized that oxygen level can affect boiler operation in various manners. If the oxygen (O₂) level is too low, the combustion process can become fuel rich because there is insufficient oxygen for all of the fuel to burn (too-low O₂ can lead to high CO-unburned fuel), and too-high O₂ can reduce boiler efficiency. Indeed, O₂ outside nominal range can lead to combustion issues or shut down. In terms of monitoring oxygen level, the oxygen level in stack flue gas can indicate excess air in combustion—that is, excessive oxygen levels in the stack flue gas at a boiler stack outlet indicates excess air in combustion. A variety of factors can influence what oxygen level may be appropriate for a given circumstance. All burners generally require “X” % excess air above stoichiometric condition to complete combustion. Excess air levels can vary based on type of burner, firing rate, NOx (nitrogen oxides, such as nitrogen monoxide and nitrogen dioxide) levels, and burners are designed for different optimum O₂ levels depending on firing rate and NOx levels. In general, excess air level goes up as firing rate is reduced. Ultra-low NOx burners typically require slightly higher excess air to meet emissions.

In view of these considerations, it will be appreciated that a user can be provided insight into boiler health (and burner health) by monitoring boiler system oxygen levels and particularly by viewing trending information about the oxygen level of a boiler's exhaust gas. Based upon trending information, various actions can be taken. For example, by trending oxygen level, it is possible to trigger combustion retune and avoid unplanned downtime. Also, if the oxygen level falls outside of the desirable range, the improved system can send a message to contact, or to prompt the contacting of, a combustion technician to evaluate the situation and retune combustion. Data analytics can be helpful in these efforts to monitor oxygen levels and provide trending information. This is especially true given that different oxygen levels are often appropriate at different operating conditions. In particular, various oxygen levels are required at different firing rates and/or to maintain consistent NOx emissions for efficient operations, and appropriate oxygen levels can vary depending upon burner design and NOx emission levels—one example of acceptable oxygen levels are shown in Table 2.

TABLE 2

| | Accepted Oxygen |
|---|---|
| Firing Rate | Levels |
| 50% to 100% | 3% to 8% |
| 1% to 49% | 3% to 11% |

Given this complexity, ML or AI models or algorithms as described above (for example, as implemented on the remote processing system 108) can facilitate monitoring and trend analysis relating to boiler oxygen levels. Such ML or AI models can be built using boiler data can track a boiler's operations in real time based upon IoT information/data and notify a boiler operator when an abnormal condition is observed.

In addition to the above, additional embodiments encompassed herein can also perform steam pressure and firing rate monitoring. It will be appreciated that any sudden change in steam pressure within a boiler system can be problematic and, if undetected for a longer period, can also lead to unscheduled down time and repairs. Large swings in boiler firing rate in a short time interval can lead to unplanned repairs as well. In this context, data analytics, and use of ML or AI models or algorithms, can be helpful for monitoring the monitor the pressure and firing rate of a boiler over a particular period(s) of time. Because the boiler data can be collected frequently (e.g., every six seconds), measuring pressure and firing rate changes over a minute or two can be done in real time, and a boiler operator can be alerted when any unusual pressure or firing rate change is observed. Data analytics and ML or AI can be particularly helpful because historical data often is not recorded and so, without data analytics and ML or AI, it can be difficult for a boiler operator to notice sudden changes. Based upon such data analytics, ML or AI, various actions can be taken including, for example, the sending of notifications for receipt by an operator. Tables 3 and 4 respectively show example changes in values at which notifications (e.g., regarding alert levels of low or high importance) are sent to the operator.

TABLE 3

| Pressure change within 60 seconds (psi) | Alert Level |
|---|---|
| 5 to 10 | Low |
| >10 | High |

TABLE 4

| Firing rate change within 60 seconds | Alert Level |
|---|---|
| 40% to 60% | Low |
| >60% | High |

In view of the above discussion, it should be appreciated that the present disclosure not only encompasses a variety of embodiments of improved systems and methods for monitoring and/or controlling boiler(s)/boiler system(s), but also encompasses a variety of embodiments of improved systems and methods that afford enhance operational monitoring and diagnostic capabilities. In at least some of these embodiments encompassed herein, information/data that is collected (e.g., by way of IoT) is made available or remote monitoring or viewing. Also, in at least some such embodiments, the collected data is leveraged by way of data analytics and ML or AI models or algorithms to achieve higher level diagnostics and allow for decisions to be made as to actions to be taken, or even to cause actions to automatically be taken. Indeed, in some such embodiments, the data analytics and ML or AI models allow for leading-indicator relationships and intelligence or other information to be discovered. Such intelligence and information can then be further utilized to generate equipment and process insights, which empower boiler operation, maintenance, and management personnel to proactively respond to identified issues before problems develop or unplanned outages occur.

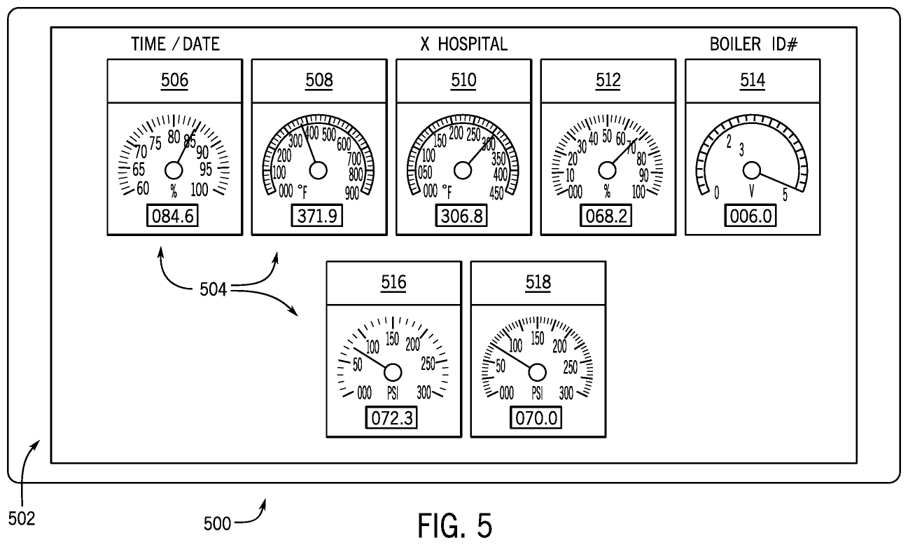

Referring additionally to FIG. 5, in at least some such embodiments, the improved systems and methods encompassed herein facilitate the monitoring or viewing of information/data that is collected (e.g., by way of IoT) as well as other information/data that is generated based upon that collected information, for example, based upon the ML or AI operating at the remote processing system 108. Effectively displaying the such information/data regarding the monitored equipment/boiler system(s) in a user-friendly format can be valuable for boiler operators, owners, customers, or other users. Further in at least some such embodiments, information/data should be available on-demand from anywhere and provide an at-a-glance overview. Thus, in at least some such embodiments or circumstances, the information/data is made available or output to a user via a user interface that, although in communication with the remote processing system 108, is nevertheless physically located remotely from it.

As illustrated in FIG. 5, the displaying of information/data in some such embodiments is provided via a user interface such as a screen of a mobile device 500, which can be an example of a customer user interface represented by the third user application(s) block 206 of FIG. 2 discussed above. The information/data that is collected or derived after processing can be displayed as various images that can appear on the screen of the mobile device 500, via a layered approach with a high-level overview of overall system status as well as detailed dashboards. Such an all-in-one viewable format enables managers or other users to spend their time reviewing and acting on the data instead of devoting excessive time sorting through it.

FIG. 5 particularly shows a first image 502 that can appear on the screen of the mobile device 500, as an example of one of the detailed dashboards that can be provided. The example dashboard shown as the first image 502 particularly includes seven gauges 504 relating to the performance of a particular boiler (having a boiler identification or serial number indicated on the screen) associated with a particular entity or institution (“X Hospital”) at a particular time/date (e.g., the displayed data is updated as of that time/date). In this example, the gauges 504 particularly include a first gauge 506 concerning boiler efficiency, a second gauge 508 concerning boiler outlet stack temperature, a third gauge 510 concerning boiler water temperature, a fourth gauge 512 concerning firing rate, a fifth gauge 514 concerning flame signal strength, a sixth gauge 516 concerning steam operating pressure, and a seventh gauge 518 concerning steam operating pressure setpoint. In other embodiments, one or more other gauges can be provided to display other characteristics in addition to or different from those shown. It will be appreciated that information shown on the gauges 504 can enable boiler operators or other users to take actions in regard to the boilers. For example, if the second dashboard gauge 508 shows that the stack temperature is running high, a boiler operator would know to check the fireside and waterside heat transfer surfaces because an increased stack temperature indicates the boiler is not transferring heat properly (e.g., because of a build-up of soot or scale on the tubes). Also, by scheduling system maintenance, the boiler will return to its normal, efficient operation.

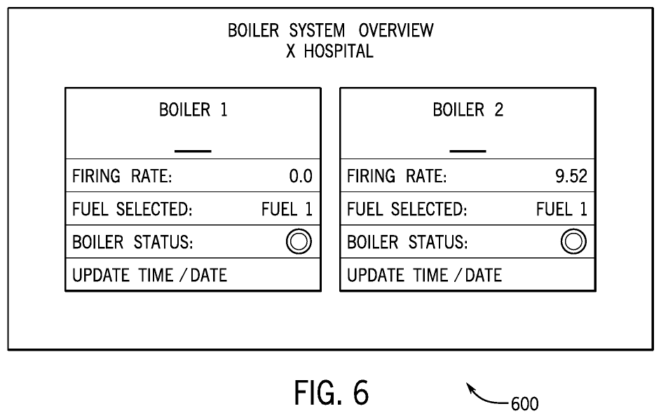

By comparison with FIG. 5, FIGS. 6, 7, and 8 are provided to show second, third, and fourth images 600, 700, and 800, respectively, which can also be presented on the screen of the mobile device 500 of FIG. 5. The images 600, 700, and 800 are additional examples of how information/data collected by (e.g., by IoT) or processed by (e.g., by the remote processing system 108) can be presented for viewing by a user. The second image 600 particularly illustrates how a high level overview of overall system status can be presented—in this example, firing rate, fuel selection, and boiler status information are displayed in relation to two (2) boilers of a boiler system of a given entity (again, “X Hospital), along with information of the applicable times/dates (e.g., the times/dates at which the information/data was most recently updated). By comparison, the third and fourth images 700 and 800 illustrate respective trend charts that communicate potential issues and provide insights for troubleshooting and system optimization. More particularly, the third image 700 shows an example trend chart concerning boiler water temperature analysis, and the fourth image 800 shows an example trend chart concerning boiler steam operating pressure analysis.

Trend charts such as those represented by the third image 700 and fourth image 800 can be particularly helpful in allowing for the effective monitoring of boiler(s)/boiler system(s) and taking actions enabling continue desired performance, or enhanced performance of boiler(s)/boiler system(s). For example, in some cases, a facility can run its boiler system at maximum for short segments. To operate the system at maximum over a long period requires close attention to data and trends. It becomes even more of an issue if new equipment is added to the system. Further for example, if a facility is already running its boiler at its maximum, and it adds a scalder or another production line, there is likelihood that the existing boiler may be unable to operate to satisfy the additional burdens placed upon it. In such a circumstance, having the ability to evaluate trend information before adding equipment or an additional line can enhance the likelihood of reliable operation.

Further in regard to trend charts and trend reporting, it should be recognized that IoT-powered devices can readily detect conditions that can lead to equipment problems and provide an alert when a monitored component is out of range. Trending and reporting capabilities made available through IoT solutions can capture boiler system anomalies, even when there is no one in the boiler room to witness them. An IoT trend report can record intricate details about a boiler system's performance. This capability enables facility personnel to examine what is happening in the boiler room at any given time, especially if there is a boiler malfunction.

It should additionally be appreciated that trend charts and trend reporting can provide a variety of different types of value to different users. Although a boiler operator is generally more tactical focused on troubleshooting an issue, a plant or maintenance manager is often more interested in long-term trends such as alarm frequency and system efficiency or annunciations like low oxygen. Trend charts and trend reporting can be especially valuable to such users who are interested in long-term trends, as trend charts and trend reporting can facilitate the uncovering of underlying problems, and also may indicate the escalation of an issue. For instance, an issue may happen once or twice during an operator's shift, which may not trigger additional analysis. However, the maintenance manager who is looking at the trend reports may see that the issue is happening once or twice during every shift, signifying an emerging problem.

Trending data can also be helpful in other respects. For example, trending data can also be helpful if there is a boiler occurrence. Being able to pull operational history can help a plant manager better understand the cause of a problem and how to prevent it from happening in the future. Also, evaluating trend data over time can help an energy manager identify ways to optimize boiler systems throughout a company from a fuel and efficiency standpoint. By regularly reviewing and acting on information detailed in the trend reports, equipment settings can be adjusted seasonally, or as needed to eliminate inefficiencies and waste. Further, regular maintenance and cleaning are important for maintaining equipment reliability. However, the cleaning process intended to maintain equipment reliability could be overloading the boiler system, which would be revealed in a trend report.

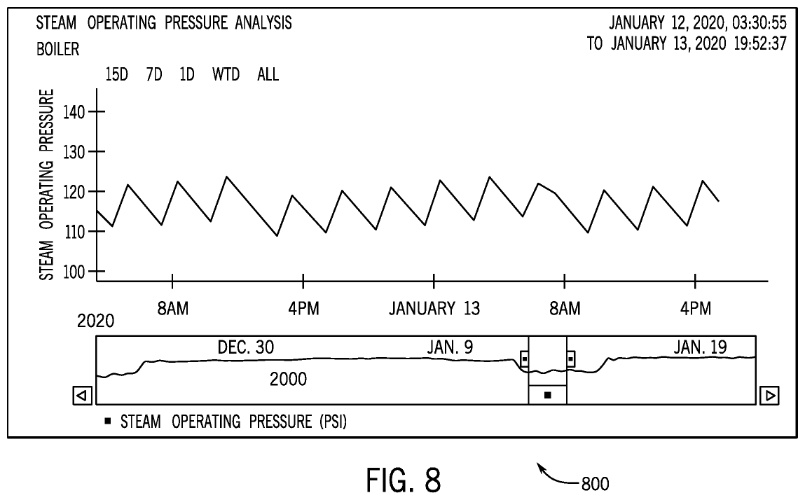

Further with respect to FIG. 8, the image 800 shown therein illustrates how trend charts and reports can be valuable in some circumstances. The image 800 relates to an example circumstance in which a particular boiler has been operating without any lockouts. Consequently, from the customer's perspective, the boiler appears to be operating properly. However, upon the boiler's operational information/data undergoing trend analysis, the resulting trend chart shown in the image 800 reveals a pattern. In particular, the trend chart illustrates that, with the boiler firing at higher rates, steam pressure in the boiler drops by 10-15 PSI. This information is of interest to a customer, as it indicates that the customer process is removing more steam than boiler is able to produce. Such operation can lead to pressure drops and swings, which ultimately can lead to unscheduled down time and boiler repair work. Thus, the trend charts and reports can help identify issues relating to boiler(s)/boiler system(s) that are of potential interest where other types of operational monitoring may not reveal such issues.

It is envisioned that embodiments of the improved systems and methods disclosed in or encompassed by the present disclosure can, depending upon the embodiment, achieve one or more advantages. Enhanced connectivity through sensors and IoT can provide facilities with more data than ever before. Acting on this meaningful data through the use of data analysis, ML and AI can enable boiler owners, operators, or customers to achieve, in a proactive manner, any of a variety of goals including, for example, reduced maintenance costs, improved uptime, and enhanced boiler operating efficiency. As discussed above, in at least some embodiments, the improved systems and methods employ ML using IoT-provided data to predict alarms or alarm conditions/states and, based upon such predictions, to take actions to avoid such alarms or alarm conditions/states and associated boiler system shutdowns, or otherwise eliminate or reduce undesired effects associated with such alarms or alarm conditions/states or boiler system shutdowns. Such boiler monitoring and predictive solutions can be of great value add to customers, particularly customers that heavily depend upon boiler twenty-four hours per day for hot steam or water without interruptions. In at least some embodiments, the improved system and methods are especially helpful because many or most of boiler-related problems can happen at times when there are few or no people in the boiler room, since the boilers are running twenty fours per day, seven days per week.

The above described ML (or AI) models also in at least some embodiments can help boiler operators in addressing the alarms at the appropriate time through remote monitoring before the alarms can happen. A significant benefit achieved through the use of IoT data, in at least some embodiments encompassed herein, is the benefit of achieving reduced unscheduled downtime (or eliminating such downtime completely). As already mentioned, IoT-powered devices can readily detect conditions that can lead to equipment failure and provide an alert when a monitored component is out of range.

Further, at least some embodiments of improved systems and methods encompassed herein are advantageous in that the improved systems and methods enable boiler operators and maintenance technicians to gain visibility into what is happening in the boiler room even when they are off-site. In some such embodiments, robust IoT solutions monitor key equipment performance indicators, and if a given indicator goes outside the acceptable range (e.g., as specified by the OEM), an alert or alarm notifies the operator and/or maintenance technician on their mobile device. Those who are notified can log into the boiler system dashboard and view live data along with trending information to start troubleshooting the issue immediately. By looking at data on the dashboard and closely monitoring alerts and alarms, maintenance technicians can recognize and address vulnerabilities that can lead to equipment failure and unplanned downtime. (and facility costs).

Having real-time data available to operators and maintenance technicians on their mobile devices provides flexibility, speeds up their response time, and helps them to discern and respond to identified issues accordingly, because those operators and technicians no longer have to frequent the boiler room to look at the gauges if they are elsewhere on company grounds or even off-site. By reviewing real-time data, they can make quicker and more educated decisions that reduce costs, increase efficiencies, improve safety, and ensure sustainability. Many facilities will find that improved systems and methods as encompassed herein (involving IoT-based monitoring) are particularly helpful for issues that arise after hours. When an alert or alarm sounds, IoT will enables the operator to easily tap into resources outside of the facility. Further, in some embodiments, a senior maintenance manager or third-party technician will be able to log in to the boiler dashboard and review the gauges and trend reports (such as those shown in FIGS. 5 to 8) before making a recommendation. This informed approach is superior to a reactive approach that might occur when a boiler goes into alarm mode.

Further, if a specialty technician is to be involved, such as a combustion expert or electrician, mobile login access can be granted. This convenience enables the specialty technician to view the boiler dashboard and determine the correct tools and parts needed to make the repairs. Paying for an outside technician to make only one trip, instead of multiple, can help a boiler return to normal operation sooner, saving a facility both time and money. For example, remote diagnostics are extremely beneficial for manufacturing facilities that stop production on the weekends. Rather than it being necessary for a maintenance manager to spend time visiting a facility to check on a boiler system over the weekend to make sure that the boiler system is ready for operation on Monday, the maintenance manager has immediate access to the boiler gauges remotely from anywhere, including home, enabling him to see if the boiler is functioning properly or possibly in an alarm state.

Additionally, at least some embodiments of improved systems and methods encompassed herein advantageously enable achieving enhanced boiler performance in terms of efficiency or productivity. IoT for the boiler room can help streamline operations and bolster production capacity. Managers and engineers can look at data trends for unit performance and compare a boiler system against a benchmark or across their locations. They can look at key performance indicators and data to rate the efficiency of each boiler system, drilling down to identify areas for improvement. It should be appreciated that efficiency is not just about cost, but also involves system resources. The efficiency between two plants may appear to be the same based upon one metric (e.g., energy usage), but the two plants perhaps should not be considered equally efficient if one plant requires more water usage per hour for the same steam output. Being able to view data over time helps facility engineers delve into reasons why the two systems are operating differently and recommend ways to improve system performance.

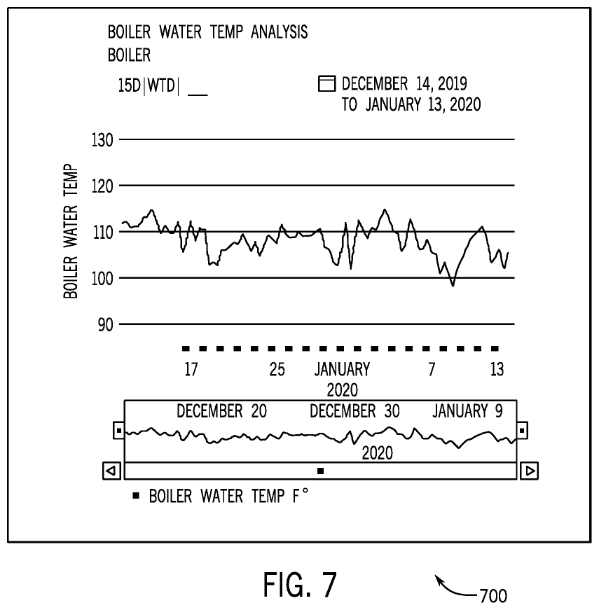

Further, as already discussed above, in at least some embodiments encompassed herein, trend information can be generated and provided to users so as to allow for optimization of boiler systems in regard to fuel and efficiency, sustainability, and other considerations metrics. The availability of long-term process data also can help an operator or maintenance technician more quickly restore a boiler to normal operation. As alerts or alarms escalate, maintenance personnel take notice. They can view boiler system and trending data on an IoT dashboard (e.g., as shown in FIG. 7 and FIG. 8), which helps provide insight into what is happening so the underlying issue can be resolved.

Embodiments described and encompassed herein also can be particularly advantageous in that the ML (or AI) models that are employed can continuously learn from the data generated by the boiler(s)/boiler system(s), and hence the models can become more accurate and evolve over time. Further, in at least some embodiments, the improved systems and method encompassed will advantageously produce, generate, and utilize high quality boiler-related data. Given that high quality data is important (or necessary) for enabling the ML (or AI) models to achieve accurate, valuable results and output, data quality reviews (or “data sanity checks”) can also be part of future deployments to enhance or ensure the quality of data that is produced, generated, or utilized.

High quality data that is produced or generated can be monetized and can be made available for customers to view as well (the data can also be made available to extended customers such as representatives and service technicians). The model output can be modified depending on the customer. Thus, implementation and availability of such data-driven ML (or AI) models as disclosed and envisioned herein will be of great value to the boiler operation industry.

Additionally, in some embodiments, additional solutions can also be developed such as solutions that achieve boiler operation improvisation and boiler part failure prediction by collecting additional data. Indeed, it is envisioned that, by employing ML (or AI) through the use of IoT with data in embodiments of improved systems and methods as disclosed or encompassed herein, many (or even most) concerns or problems relating to the monitoring and controlling of boilers or boiler systems experienced in the boiler industry can be addressed, ameliorated, or solved.

In some embodiments envisioned herein (e.g., as future applications), in which both IoT and ML are employed, the improved systems (or methods) can be considered AI systems (or methods). This can be the case particularly in some embodiments in which the improved system (or method) for monitoring or controlling boiler(s)/boiler system(s) (or the overall improved boiler(s)/boiler system(s)) can make its own decision based on the model outcome. In general, for such AI to be useful, large amounts of data are beneficial (or required), because the model provides improved decisions as the model is fed and based upon more examples. In at least some embodiments, decisions will be automatically made or taken by way of the ML or AI model/solution (e.g., as implemented at the remote processing system 108), and actions will be taken based upon those decisions. Some actions that can be taken based upon such decisions can include, for example, the sending of instructions to the PLC controllers (e.g., the PLC controllers 106) to change one or more settings of the boiler(s)/boiler system(s). For example, when the ML or AI model detects that the boiler operations need more fire, the firing rate will increase automatically based on the data. It is envisioned that this type of intelligence can be developed and implemented using a ML-enabled or AI-enabled PLC system backed up with big data.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method of anticipating shutdown alarms for a boiler system by way of one or more machine learning models, the method comprising:
providing a boiler system having a controller and a plurality of sensors associated with a plurality of internet of things (IoT) devices, wherein the sensors are configured to sense a plurality of parameters regarding the boiler system and to provide a plurality of first signals regarding the sensed parameters to the controller;
causing all of the first signals regarding the sensed parameters regarding the boiler system, or information based upon the first signals, to be stored with at least one memory device, so as to maintain a historical database of the first signals or information based upon the first signals;
sending the first signals regarding the sensed parameters, or second signals based at least indirectly upon the first signals, to at least one gateway device of the boiler system;
further sending the first signals, the second signals, or third signals based at least indirectly upon the first signals or second signals, from the gateway device, for receipt by a cloud computing system and for use in either developing the one or more machine learning models for predicting the shutdown alarms or generating at least one prediction of one or more of the shutdown alarms by way of the one or more machine learning models; and
receiving the at least one prediction of the one or more of the shutdown alarms.

2. The method of claim 1, wherein the at least one prediction includes a probability value as to a likelihood that the one or more the shutdown alarms will occur within a first time period.

3. The method of claim 2, wherein the at least one prediction includes a plurality of predictions regarding whether any of the one or more of the shutdown alarms will occur during each of the first time period, a second time period, or a third time period.

4. The method of claim 3, wherein the plurality of predictions includes a first prediction regarding whether a first of the one or more shutdown alarms will occur within the first time period based upon 90 minute interval data, a second prediction regarding whether the first shutdown alarm will occur within the second time period based upon 60 minute interval data, and a third prediction regarding whether the first shutdown alarm will occur within the third time period based upon 30 minute interval data.

5. The method of claim 4, wherein the second prediction is based at least in part upon the first prediction, and the third prediction is based at least in part upon the second prediction, as generated by the one or more machine learning models operating in a sequential manner.

6. The method of claim 4, wherein the first, second, and third predictions are generated by the one or more machine learning models operating in an independent manner.

7. The method of claim 1, wherein the plurality of parameters concern one or more of a firing rate, an oxygen level, a fuel valve position, a type of fuel, a stack temperature, a water temperature, or a flame strength of the boiler system.

8. The method of claim 2, wherein the further sending of the first, second, or third signals for receipt by the cloud system is streamed and occurs at least in part by way of wireless communications.

9. The method of claim 1, further comprising displaying, on a display associated with the boiler system, the at least one prediction of the one or more shutdown alarms, or one or more alerts in response to the at least one prediction of the one or more shutdown alarms, by way of a user interface associated with the boiler system, by way of an application programming interface (API).

10. The method of claim 9, further comprising providing a recommendation of an action to be taken in view of the at least one prediction or the one or more alerts, wherein the action concerns any one or more of checking a pilot flame, checking a burner, checking an ignition status or feature, checking a fuel supply, or checking a communication from a flame safe guard.

11. The method of claim 1, wherein the one or more machine learning models include one or more of a LSTM neural network model, an Xgboost model, or a random forest model.

12. The method of claim 1, wherein the one or more machine learning models enable an artificial intelligence system to operate that renders one or more decisions.

13. The method of claim 1, further comprising performing data preprocessing and feature engineering prior to the developing of the one or more machine learning models for predicting the shutdown alarms or the generating of the at least one prediction of the one or more of the shutdown alarms by way of the one or more machine learning models.

14. The method of claim 1, wherein the one or more models include a plurality of machine learning models that are trained for to predict the shutdown alarms for a plurality of different types of boilers.

15. The method of claim 1, wherein the boiler system includes a lead boiler and at least one lag boiler, wherein the at least one prediction of the one or more of the shutdown alarms that is generated by way of the one or more machine learning models pertains to the lead boiler, and wherein the one or more machine learning models take into account data patterns concerning interrelated operations between the lead boiler and the at least one lag boiler, or between other lead boilers and other lag boilers of other boiler systems.

16. A system for anticipating shutdown alarms with respect to a boiler by way of machine learning model processing of information obtained by way of a plurality of internet of things (IoT) devices, the system comprising:
a first controller supported on or proximate to the boiler;
a plurality of sensors associated with the plurality of internet of things (IoT) devices and also supported on or positioned proximate to the boiler, wherein the sensors are configured to sense a plurality of parameters regarding the boiler and to provide a plurality of first signals regarding the sensed parameters to the controller;
a gateway device of the boiler, wherein either the first signals or second signals based at least indirectly upon the first signals are sent to the gateway device;
at least one communications device by which either the first signals, the second signals, or third signals based at least indirectly upon the first signals or second signals, are sent for receipt by a cloud computing system, for use in either developing one or more machine learning models for predicting the shutdown alarms or generating at least one prediction of one or more of the shutdown alarms by way of the one or more machine learning models; and
a display configured to receive at least one fourth signal indicative of the at least one prediction of the one or more of the shutdown alarms, and to display either the at least one prediction or one or more alerts in response to the at least one prediction, by way of an application programming interface (API).

17. The system of claim 18, wherein the at least one communications device includes at least one wireless communications device.

18. The system of claim 18, wherein the boiler is a lead boiler that operates with one or more lag boilers.

19. A method for anticipating shutdown alarms with respect to a boiler by way of a machine learning model, the method comprising:
receiving and storing, at one or more storage devices, a plurality of types of boiler-related data,
wherein the plurality of types of boiler-related data are received at least indirectly from a plurality of internet of things (IoT) devices associated with either the boiler or one or more additional boilers, and
wherein the plurality of types of boiler-related data include each of firing rate data, oxygen level data, water level data, water temperature data, and fuel valve condition data;
preprocessing and feature engineering the plurality of types of boiler-related data to arrive at a training data set;
training the machine learning model at least in part based upon the training data set;
deploying the trained machine learning model;
receiving additional boiler-related data concerning the boiler and, by way of the deployed, trained machine learning model and based upon the additional boiler-related data, determining an alarm prediction concerning an anticipated alarm regarding the boiler; and
taking at least one action based at least upon the prediction concerning the anticipated alarm regarding the boiler.

20. The method of claim 19, wherein the machine learning model includes first, second, and third machine learning models that respectively produce first, second, and third predictions, respectively, and wherein the alarm prediction is based at least indirectly upon each of the first, second, and third predictions, and wherein the at least one action includes either a sending of an alert message for receipt by a boiler operator at a user interface, or a command causing a status check concerning one or more of (a) a pilot flame at the boiler, (b) a burner status at the boiler, (c) an ignition at the boiler; (d) a fuel supply for the boiler, and (c) a communication from a flame safe guard at the boiler.
